(19) United States
(12) Patent Application Publication
(10) Pub. No.: US 2020/0004087 A1
(43) Pub. Date: Jan. 2, 2020

(54) PHOTO-ALIGNMENT COPOLYMER, PHOTO-ALIGNMENT FILM, AND OPTICAL LAMINATE

(71) Applicant: FUJIFILM Corporation, Tokyo (JP)

(72) Inventors: Yutaka NOZOE, Minamiashigara-shi (JP); Takashi IIZUMI, Minamiashigara-shi (JP); Takahiro KATO, Minamiashigara-shi (JP)

(73) Assignee: FUJIFILM Corporation, Tokyo (JP)

(21) Appl. No.: 16/558,841

(22) Filed: Sep. 3, 2019

Related U.S. Application Data
(63) Continuation of application No. PCT/JP2018/008439, filed on Mar. 6, 2018.

(30) Foreign Application Priority Data
Mar. 24, 2017 (JP) 2017-059490
Oct. 16, 2017 (JP) 2017-200346
Feb. 28, 2018 (JP) 2018-034730

(51) Int. Cl. G02F 1/1337; C08F 220/30; C08F 220/32; G02F 1/13363

(52) U.S. Cl. CPC G02F 1/133711; G02F 1/13363; C08F 220/32; C08F 220/30

(57) ABSTRACT

A photo-alignment copolymer has a repeating unit A including a photo-alignment group represented by Formula (1), and a repeating unit B including a crosslinkable group represented by Formula (2), a photo-alignment film is formed using a photo-alignment film composition containing the photo-alignment copolymer, an optical laminate has the photo-alignment film and an optically anisotropic layer, and an image display device has the optical laminate.

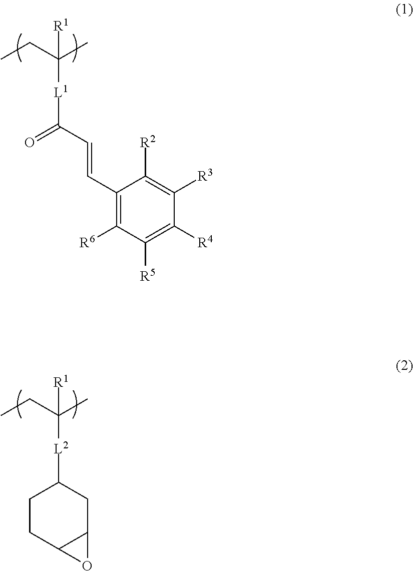

### CROSS-REFERENCE TO RELATED APPLICATIONS

This application is a Continuation of PCT International Application No. PCT/JP2018/008439 filed on Mar. 6, 2018, which claims priority under 35 U.S.C § 119(a) to Japanese Patent Application No. 2018-034730 filed on Feb. 28, 2018, Japanese Patent Application No. 2017-200346 filed on Oct. 16, 2017, and Japanese Patent Application No. 2017-059490 filed on Mar. 24, 2017. Each of the above application(s) is hereby expressly incorporated by reference, in its entirety, into the present application.

### BACKGROUND OF THE INVENTION

### 1. Field of the Invention

The present invention relates to a photo-alignment copolymer, a photo-alignment film, and an optical laminate.

### 2. Description of the Related Art

Optical films such as optical compensation sheets or retardation films are used in various image display devices from the viewpoint of solving image staining or enlarging a view angle.

A stretched birefringence film has been used as an optical film, but in recent years, it has been proposed to use an optically anisotropic layer formed of a liquid crystal compound in place of the stretched birefringence film.

Regarding such an optically anisotropic layer, it has been known that in order to align a liquid crystal compound, an alignment film is provided on a support on which the optically anisotropic layer is to be formed. As the alignment film, a photo-alignment film subjected to a photo-alignment treatment in place of a rubbing treatment has been known.

For example, WO2010/150748A discloses a liquid crystal alignment layer formed from a thermosetting film forming composition containing a crosslinking agent and an acrylic copolymer having a photodimerized moiety such as a cinnamoyl group ([claim 1], [claim 3], [claim 11], and <0028>).

### SUMMARY OF THE INVENTION

The inventors have conducted studies on, as the acrylic copolymer described in WO2010/150748A, an acrylic copolymer obtained by copolymerizing a monomer having a photodimerized moiety and a monomer having a thermal crosslinking moiety, and found that a photo-alignment film formed using the acrylic copolymer to be obtained may have poor heat resistance.

Accordingly, an object of the invention is to provide a photo-alignment copolymer capable of producing a photo-alignment film having excellent heat resistance, and a photo-alignment film and an optical laminate produced using the photo-alignment copolymer.

As a result of intensive studies for achieving the above object, the inventors have found that a photo-alignment film to be formed has excellent heat resistance in a case where a copolymer having a repeating unit including a specific photo-alignment group and a repeating unit containing a specific crosslinkable group is used, and completed the invention.

That is, the inventors have found that the object can be achieved with the following configuration.

[1] A photo-alignment copolymer comprising: a repeating unit A including a photo-alignment group represented by Formula (1); and a repeating unit B including a crosslinkable group represented by Formula (2).

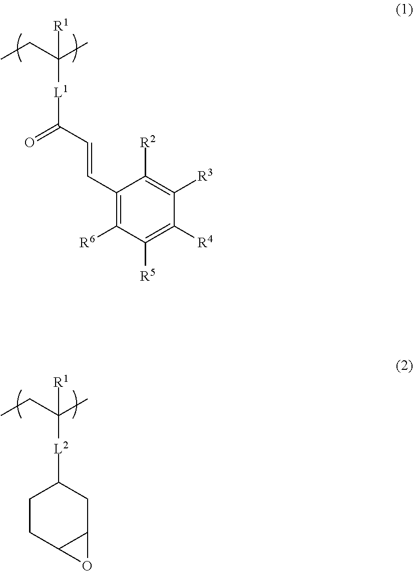

In Formula (1), R¹ represents a hydrogen atom or a methyl group, R², R³, R⁴, R⁵, and R⁶ each independently represent a hydrogen atom or a substituent, and among R², R³, R⁴, R⁵, and R⁶, two adjacent groups may be bonded to form a ring.

In Formula (2), R⁷ represents a hydrogen atom or a methyl group.

L¹ in Formula (1) and L² in Formula (2) each independently represent a divalent linking group formed by combining at least two or more groups selected from the group consisting of a linear, branched, or cyclic alkylene group having 1 to 10 carbon atoms and optionally having a substituent A, an arylene group having 6 to 12 carbon atoms and optionally having a substituent B, an ether group, a carbonyl group, and an imino group optionally having a substituent C.

The substituent A is at least one substituent selected from the group consisting of a halogen atom, an alkyl group, and an alkoxy group, the substituent B is at least one substituent selected from the group consisting of a halogen atom, an alkyl group, an aryl group, an alkoxy group, an aryloxy group, a cyano group, a carbonyl group, and an alkoxycarbonyl group, and the substituent C is at least one substituent selected from the group consisting of an alkyl group and an aryl group.

[2] The photo-alignment copolymer according to [1], in which L¹ in Formula (1) is a divalent linking group including any of a linear alkylene group having 1 to 10 carbon atoms and optionally having a substituent A, a cyclic alkylene group having 3 to 10 carbon atoms and optionally having a substituent A, and an arylene group having 6 to 12 carbon atoms and optionally having a substituent B.

[3] The photo-alignment copolymer according to [2], in which L¹ in Formula (1) is a divalent linking group including a linear alkylene group having 1 to 10 carbon atoms and optionally having a substituent A or a cyclic alkylene group having 3 to 10 carbon atoms and optionally having a substituent A.

[4] The photo-alignment copolymer according to any one of [1] to [3], in which at least R⁴ among R², R³, R⁴, R⁵, and R⁶ in Formula (1) represents a substituent.

[5] The photo-alignment copolymer according to [4], in which R², R³, R⁵, and R⁶ in Formula (1) all represent a hydrogen atom.

[6] The photo-alignment copolymer according to any one of [1] to [5], in which R⁴ in Formula (1) is an electron-donating substituent.

[7] The photo-alignment copolymer according to any one of [1] to [6], in which the substituents represented by R², R³, R⁴, R⁵, and R⁶ in Formula (1) each independently represent a halogen atom, a linear, branched, or cyclic alkyl group having 1 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, an amino group, or a group represented by Formula (3).

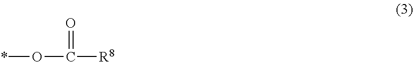

In Formula (3), * represents a bonding position with a benzene ring in Formula (1), and R⁸ represents a monovalent organic group.

[8] The photo-alignment copolymer according to any one of [1] to [7], in which a content X of the repeating unit A and a content Y of the repeating unit B satisfy Formula (4).

0.2≤X/(X+Y)≤0.8 (4)

[9] The photo-alignment copolymer according to [8], in which a content X of the repeating unit A and a content Y of the repeating unit B satisfy Formula (5).

0.2≤X/(X+Y)≤0.6 (5)

[10] The photo-alignment copolymer according to any one of [1] to [9], in which a weight-average molecular weight is 10,000 to 500,000.

[11] The photo-alignment copolymer according to [10], in which a weight-average molecular weight is 30,000 to 200,000.

[12] The photo-alignment copolymer according to any one of [1] to [10], further comprising: a repeating unit C represented by Formula (6).

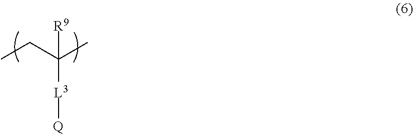

In Formula (6), R⁹ represents a hydrogen atom or a methyl group.

In Formula (6), L³ represents a divalent linking group formed by one group or combining one or more groups selected from the group consisting of a linear, branched, or cyclic alkylene group having 1 to 10 carbon atoms and optionally having the substituent A, an arylene group having 6 to 12 carbon atoms and optionally having the substituent B, an ether group, a carbonyl group, and an imino group optionally having the substituent C.

In Formula (6), Q represents any group of —OH, —COOH, and —COOtBu.

The photo-alignment copolymer in which any one of L¹ in Formula (1) and L² in Formula (2) is a divalent linking group including a branched, or cyclic alkylene group having 3 to 10 carbon atoms and optionally having a substituent A is preferable.

The photo-alignment copolymer in which any one of L¹ in Formula (1) and L² in Formula (2) is a divalent linking group including an imino group optionally having a substituent C is preferable.

The photo-alignment copolymer in which L¹ in Formula (1) is a divalent linking group including a cyclic alkylene group having 3 to 10 carbon atoms and optionally having a substituent A is preferable.

The photo-alignment copolymer in which L¹ in Formula (1) is a divalent linking group including a cyclic alkylene group having 3 to 10 carbon atoms and optionally having a substituent A or an imino group optionally having a substituent C, and L² in Formula (2) is a divalent linking group including an imino group optionally having a substituent C is preferable.

[13] A photo-alignment film which is formed using a photo-alignment film composition containing the photo-alignment copolymer according to any one of [1] to [12].

[14] An optical laminate comprising: the photo-alignment film according to [13]; and an optically anisotropic layer which is formed using a liquid crystal composition containing a liquid crystal compound.

According to the invention, it is possible to provide a photo-alignment copolymer capable of producing a photo-alignment film having excellent heat resistance, and a photo-alignment film and an optical laminate produced using the photo-alignment copolymer.

### DESCRIPTION OF THE PREFERRED EMBODIMENTS

Hereinafter, the invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

[Photo-Alignment Copolymer]

A photo-alignment copolymer according to the embodiment of the invention is a copolymer with photo-alignment properties which has a repeating unit A including a photo-alignment group represented by Formula (1) and a repeating unit B including a crosslinkable group represented by Formula (2).

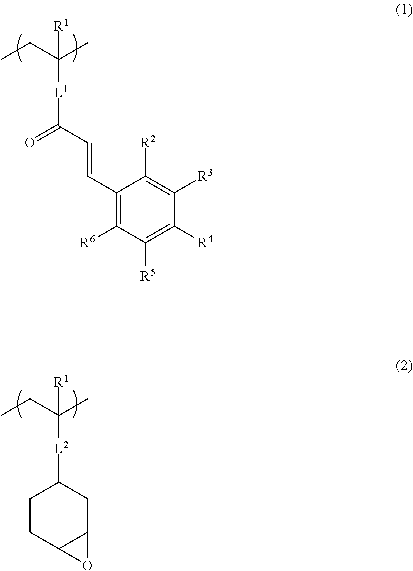

In Formula (1), R¹ represents a hydrogen atom or a methyl group, and R², R³, R⁴, R⁵, and R⁶ each independently represent a hydrogen atom or a substituent. Among R², R³, R⁴, R⁵, and R⁶, two adjacent groups may be bonded to form a ring.

In Formula (2), R⁷ represents a hydrogen atom or a methyl group.

L¹ in Formula (1) and L² in Formula (2) each independently represent a divalent linking group formed by combining at least two or more groups selected from the group consisting of a linear, branched, or cyclic alkylene group having 1 to 10 carbon atoms and optionally having a substituent A, an arylene group having 6 to 12 carbon atoms and optionally having a substituent B, an ether group (—O—), a carbonyl group (—C(═O)—), and an imino group (—NH—) optionally having a substituent C.

Here, the substituent A is at least one substituent selected from the group consisting of a halogen atom, an alkyl group, and an alkoxy group. The substituent B is at least one substituent selected from the group consisting of a halogen atom, an alkyl group, an aryl group, an alkoxy group, an aryloxy group, a cyano group, a carbonyl group, and an alkoxycarbonyl group. The substituent C is at least one substituent selected from the group consisting of an alkyl group and an aryl group.

Examples of the halogen atom include a fluorine atom, a chlorine atom, a bromine atom, and an iodine atom. Among these, a fluorine atom and a chlorine atom are preferable.

The alkyl group is, for example, preferably a linear, branched, or cyclic alkyl group having 1 to 18 carbon atoms, more preferably an alkyl group having 1 to 8 carbon atoms (for example, a methyl group, an ethyl group, a propyl group, an isopropyl group, an n-butyl group, an isobutyl group, a sec-butyl group, a t-butyl group, a cyclohexyl group, and the like), even more preferably an alkyl group having 1 to 4 carbon atoms, and particularly preferably a methyl group or an ethyl group.

The alkoxy group is, for example, preferably an alkoxy group having 1 to 18 carbon atoms, more preferably an alkoxy group having 1 to 8 carbon atoms (for example, a methoxy group, an ethoxy group, an n-butoxy group, a methoxyethoxy group, and the like), even more preferably an alkoxy group having 1 to 4 carbon atoms, and particularly preferably a methoxy group or an ethoxy group.

Examples of the aryl group include an aryl group having 6 to 12 carbon atoms. Specific examples thereof include a phenyl group, an α-methylphenyl group, and a naphthyl group. Among these, a phenyl group is preferable.

Examples of the aryloxy group include phenoxy, naphthoxy, imidazoyloxy, benzimidazoyloxy, pyridin-4-yloxy, pyrimidinyloxy, quinazolinyloxy, purinyloxy, and thiophen-3-yloxy.

Examples of the alkoxycarbonyl group include methoxycarbonyl and ethoxycarbonyl.

Regarding the linear, branched, or cyclic alkylene group having 1 to 10 carbon atoms, specific examples of the linear alkylene group include a methylene group, an ethylene group, a propylene group, a butylene group, a pentylene group, a hexylene group, and a decylene group.

Specific examples of the branched alkylene group include a dimethylmethylene group, a methylethylene group, a 2,2-dimethylpropylene group, and a 2-ethyl-2-methylpropylene group.

Specific examples of the cyclic alkylene group include a cyclopropylene group, a cyclobutylene group, a cyclopentylene group, a cyclohexylene group, a cyclooctylene group, a cyclodecylene group, an adamantane-diyl group, a norbornane-diyl group, and an exo-tetrahydrodicyclopentadiene-diyl group. Among these, a cyclohexylene group is preferable.

Specific examples of the arylene group having 6 to 12 carbon atoms include a phenylene group, a xylylene group, a biphenylene group, a naphthylene group, and a 2,2′-methylenebisphenyl group. Among these, a phenylene group is preferable.

In the invention, since the rigidity of a photo-alignment copolymer to be obtained is improved, and the heat resistance of a photo-alignment film to be produced is further improved, L¹ in Formula (1) is preferably a divalent linking group including at least any of a linear alkylene group having 1 to 10 carbon atoms and optionally having the substituent A, a cyclic alkylene group having 3 to 10 carbon atoms and optionally having the substituent A, and an arylene group having 6 to 12 carbon atoms and optionally having the substituent B, more preferably a divalent linking group including at least a linear alkylene group having 1 to 10 carbon atoms and optionally having the substituent A, or a cyclic alkylene group having 3 to 10 carbon atoms and optionally having the substituent A, and particularly preferably a divalent linking group including an unsubstituted linear alkylene group having 2 to 6 carbon atoms, or unsubstituted trans-1,4-cyclohexylene.

Next, the substituents represented by R², R³, R⁴, R⁵, and R⁶ in Formula (1) will be described. R², R³, R⁴, R⁵, and R⁶ in Formula (1) may be not substituents but hydrogen atoms as described above.

Since the photo-alignment group becomes easy to interact with the liquid crystal compound, and the aligning properties (hereinafter, abbreviated as “liquid crystal aligning properties”) of the liquid crystal compound in an optically anisotropic layer to be formed on a photo-alignment film are thus improved, the substituents represented by R², R³, R⁴, R⁵, and R⁶ in Formula (1) each independently preferably represent a halogen atom, a linear, branched, or cyclic alkyl group having 1 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, an amino group, or a group represented by Formula (3).

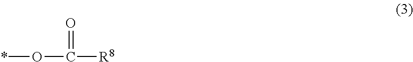

Here, in Formula (3), * represents a bonding position with a benzene ring in Formula (1), and R⁸ represents a monovalent organic group.

Examples of the halogen atom include a fluorine atom, a chlorine atom, a bromine atom, and an iodine atom. Among these, a fluorine atom and a chlorine atom are preferable.

Regarding the linear, branched, or cyclic alkyl group having 1 to 20 carbon atoms, the linear alkyl group is preferably an alkyl group having 1 to 6 carbon atoms. Specific examples thereof include a methyl group, an ethyl group, and an n-propyl group.

The branched alkyl group is preferably an alkyl group having 3 to 6 carbon atoms, and specific examples thereof include an isopropyl group and a tert-butyl group.

The cyclic alkyl group is preferably an alkyl group having 3 to 6 carbon atoms, and specific examples thereof include a cyclopropyl group, a cyclopentyl group, and a cyclohexyl group.

The linear halogenated alkyl group having 1 to 20 carbon atoms is preferably a fluoroalkyl group having 1 to 4 carbon atoms, and specific examples thereof include a trifluoromethyl group, a perfluoroethyl group, a perfluoropropyl group, and a perfluorobutyl group. Among these, a trifluoromethyl group is preferable.

The alkoxy group having 1 to 20 carbon atoms is preferably an alkoxy group having 1 to 18 carbon atoms, more preferably an alkoxy group having 6 to 18 carbon atoms, and even more preferably an alkoxy group having 6 to 14 carbon atoms. Specifically, suitable examples thereof include a methoxy group, an ethoxy group, an n-butoxy group, a methoxyethoxy group, an n-hexyloxy group, an n-octyloxy group, an n-decyloxy group, an n-dodecyloxy group, and an n-tetradecyloxy group, and an n-hexyloxy group, an n-octyloxy group, an n-decyloxy group, an n-dodecyloxy group, and an n-tetradecyloxy group are more preferable.

The aryl group having 6 to 20 carbon atoms is preferably an aryl group having 6 to 12 carbon atoms, and specific examples thereof include a phenyl group, an α-methylphenyl group, and a naphthyl group. Among these, a phenyl group is preferable.

The aryloxy group having 6 to 20 carbon atoms is preferably an aryloxy group having 6 to 12 carbon atoms, and specific examples thereof include a phenyloxy group and a 2-naphthyloxy group. Among these, a phenyloxy group is preferable.

Examples of the amino group include: primary amino groups (—NH₂); secondary amino groups such as a methylamino group; and tertiary amino groups such as a dimethylamino group, a diethylamino group, a dibenzylamino group, and a group having a nitrogen atom of a nitrogen-containing heterocyclic compound (for example, pyrrolidine, piperidine, and piperazine) as a bond.

Regarding the group represented by Formula (3), examples of the monovalent organic group represented by R⁸ in Formula (3) include a linear or cyclic alkyl group having 1 to 20 carbon atoms.

The linear alkyl group is preferably an alkyl group having 1 to 6 carbon atoms, and specific examples thereof include a methyl group, an ethyl group, and an n-propyl group. Among these, a methyl group or an ethyl group is preferable.

The cyclic alkyl group is preferably an alkyl group having 3 to 6 carbon atoms, and specific examples thereof include a cyclopropyl group, a cyclopentyl group, and a cyclohexyl group. Among these, a cyclohexyl group is preferable.

The monovalent organic group represented by R⁸ in Formula (3) may be made by combining the linear alkyl group and the cyclic alkyl group described above directly or via a single bond.

In the invention, since the photo-alignment group becomes easy to interact with the liquid crystal compound, and the aligning properties are thus improved, at least R⁴ among R², R³, R⁴, R⁵, and R⁶ in Formula (1) preferably represents the above-described substituent. Moreover, since the rigidity of a photo-alignment copolymer to be obtained is improved, and the heat resistance of a photo-alignment film to be produced is further improved, it is more preferable that R², R³, R⁵, and R⁶ all represent a hydrogen atom.

In the invention, R⁴ in Formula (1) is preferably an electron-donating substituent since the reaction efficiency is improved in a case where a photo-alignment film to be obtained is irradiated with light.

Here, the electron-donating substituent (electron-donating group) refers to a substituent having a Hammett value (Hammett substituent constant σp) of 0 or less, and an alkyl group, a halogenated alkyl group, an alkoxy group, and the like are exemplified among the above-described substituents.

Specific examples of the repeating unit A including a photo-alignment group represented by Formula (1) include repeating units A-1 to A-116 shown below. In the following formulae, Me represents a methyl group.

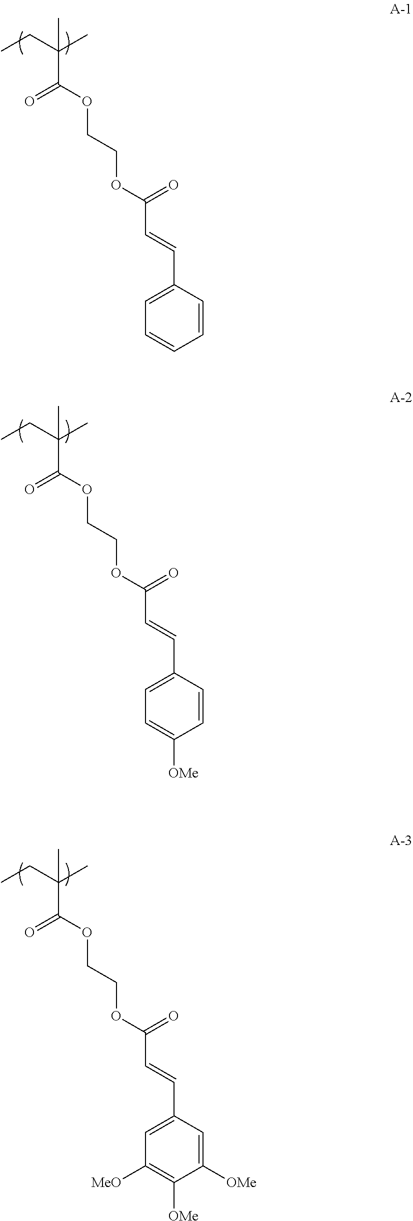

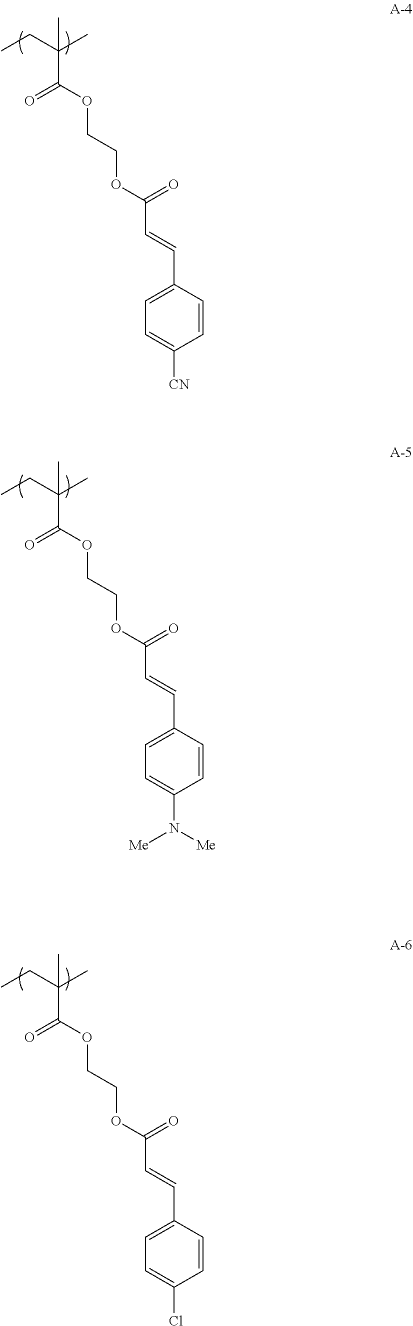

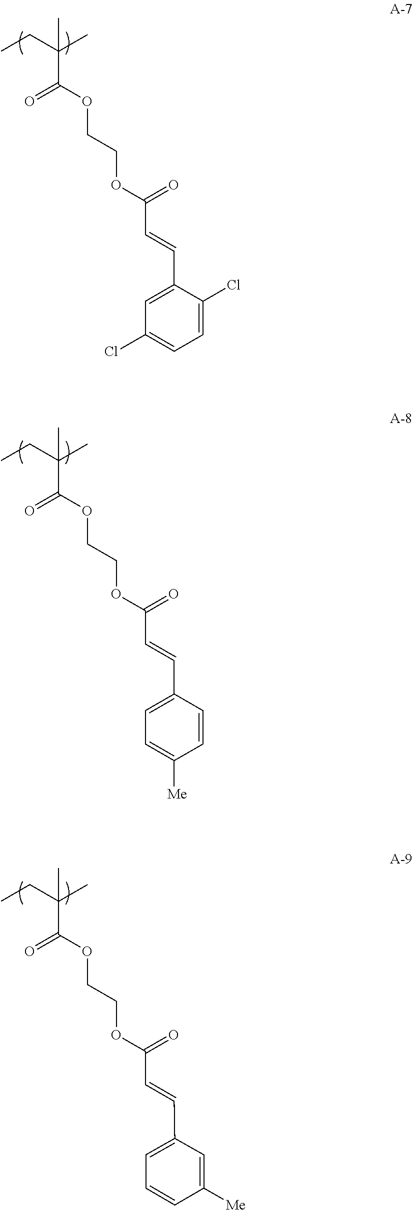

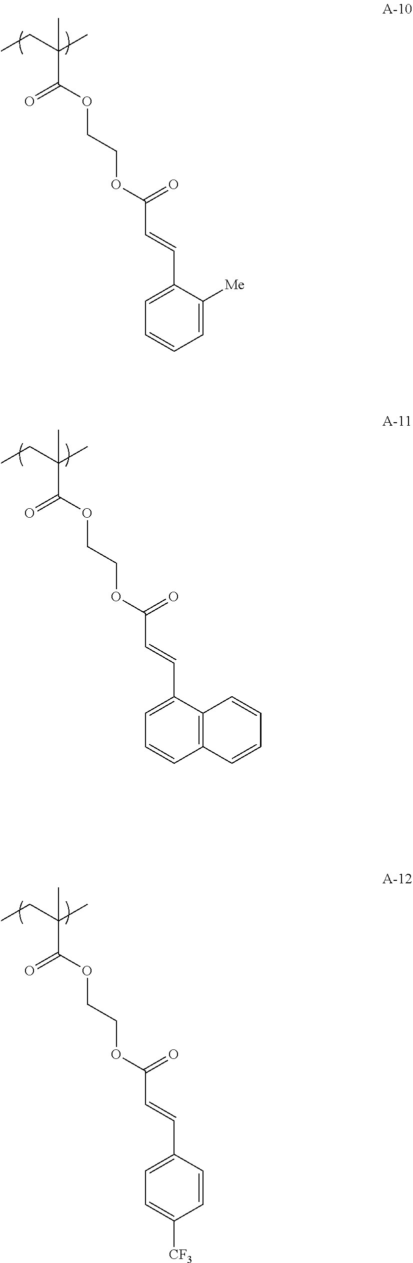

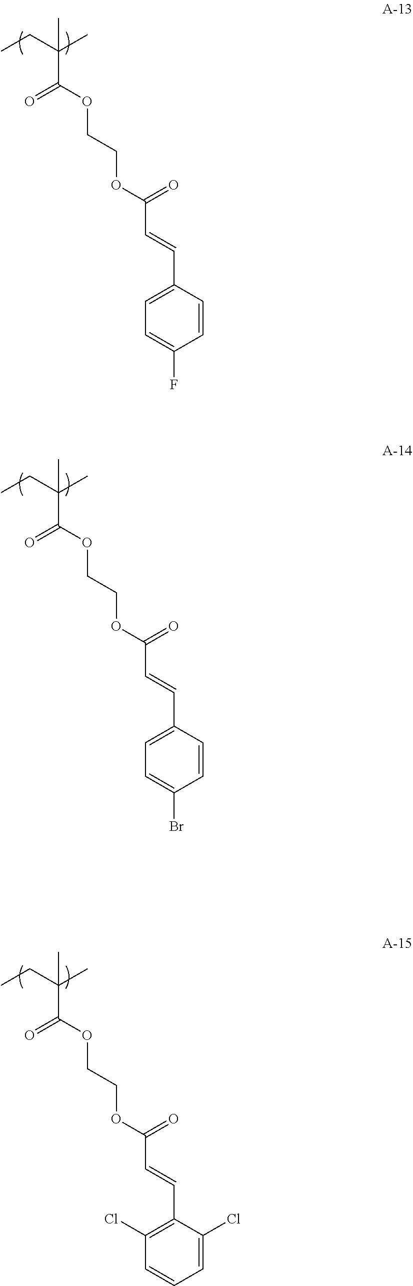

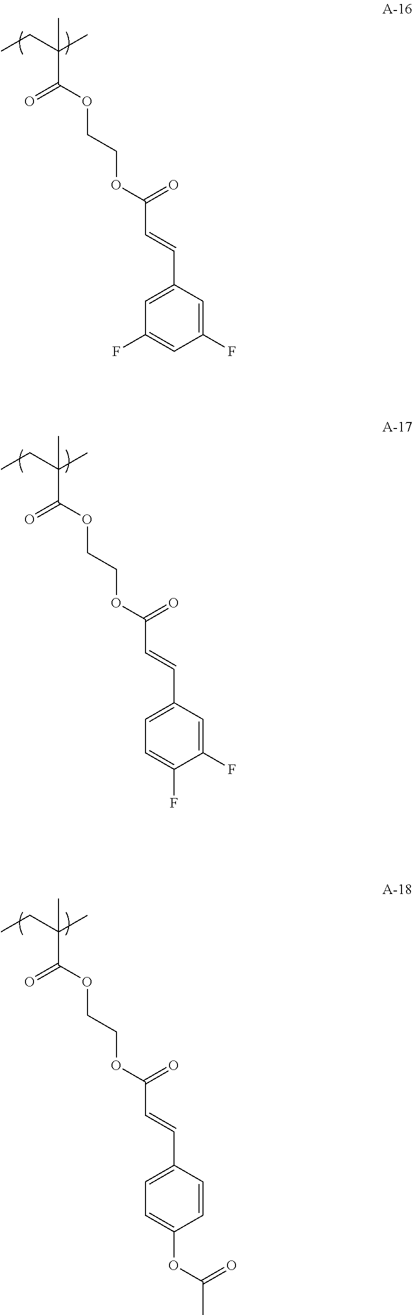

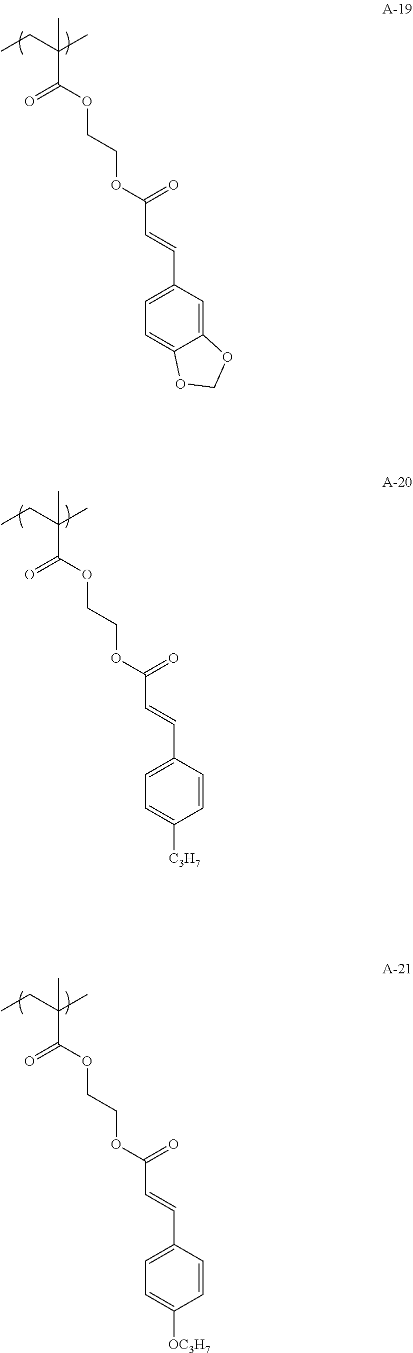

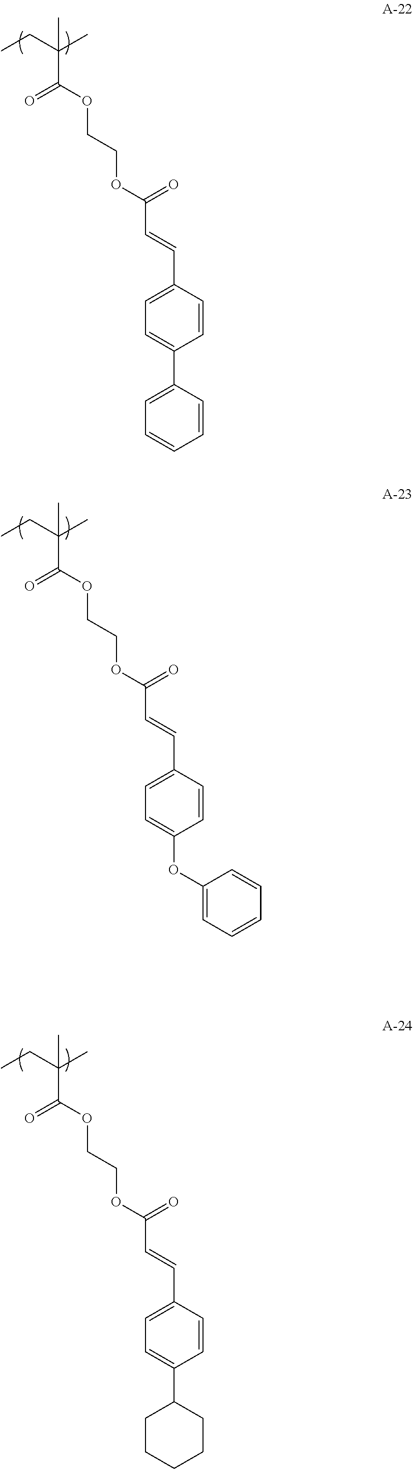

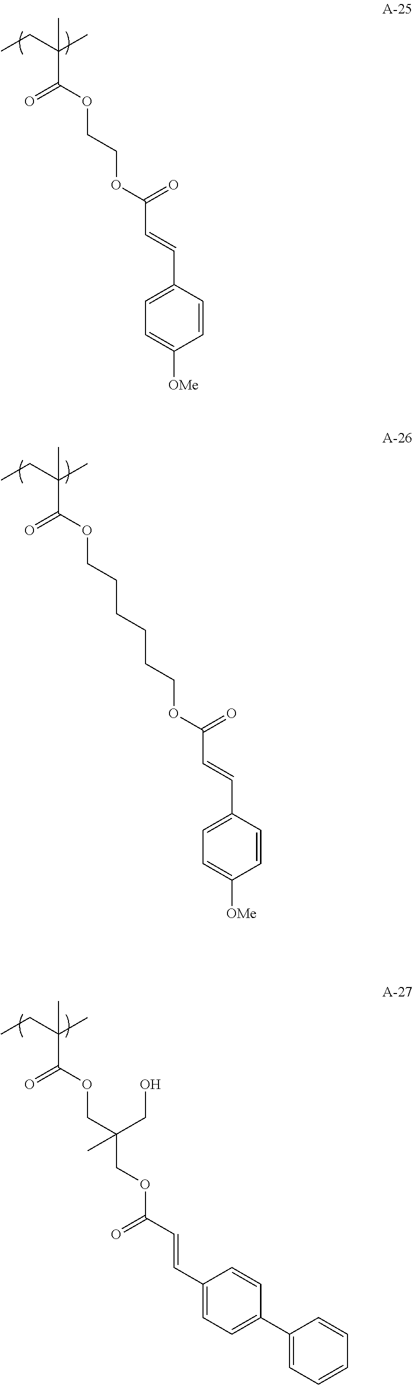

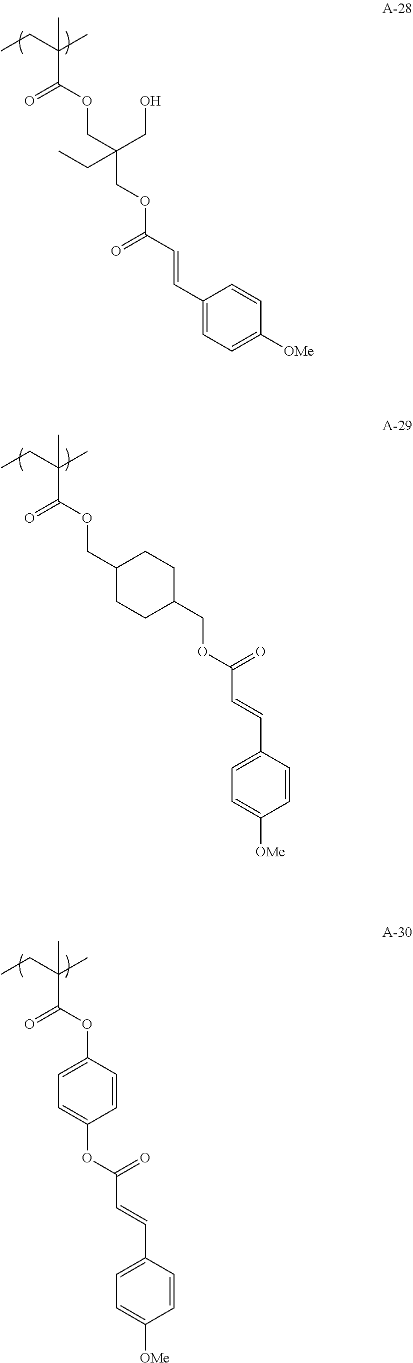

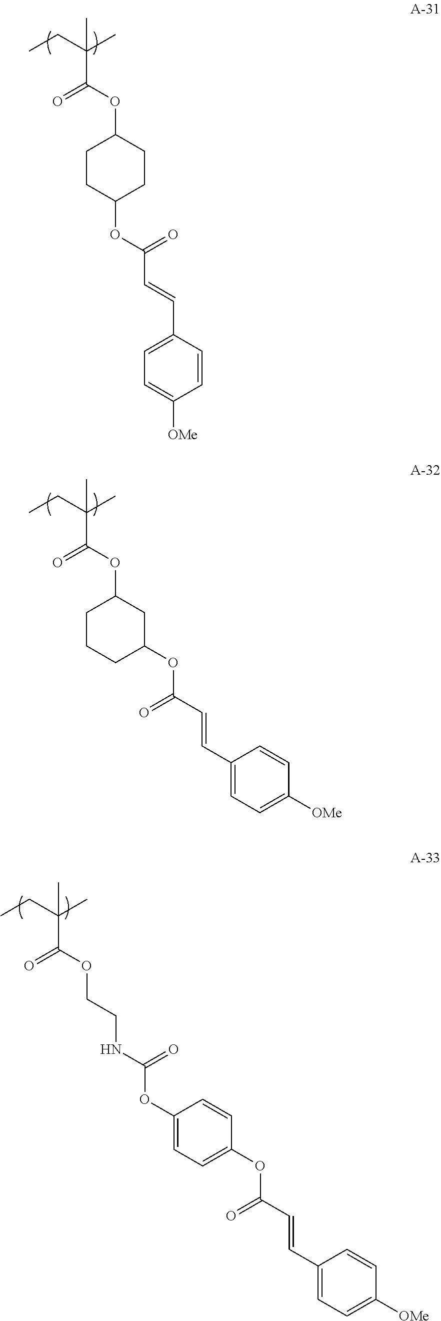

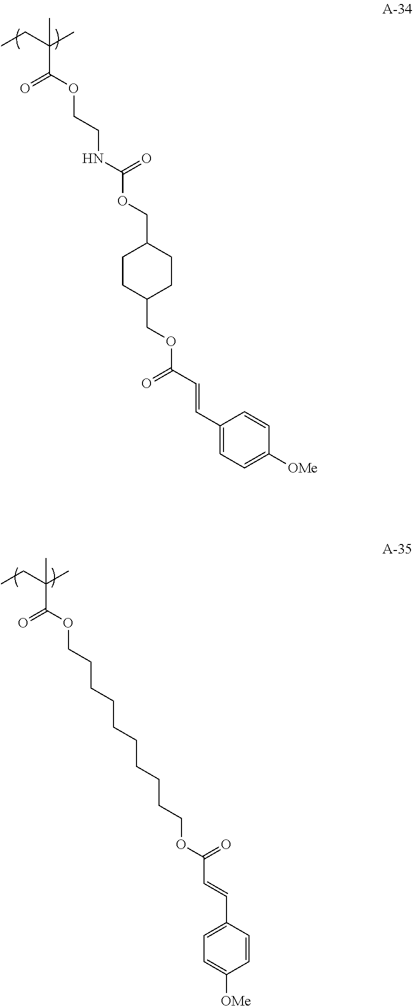

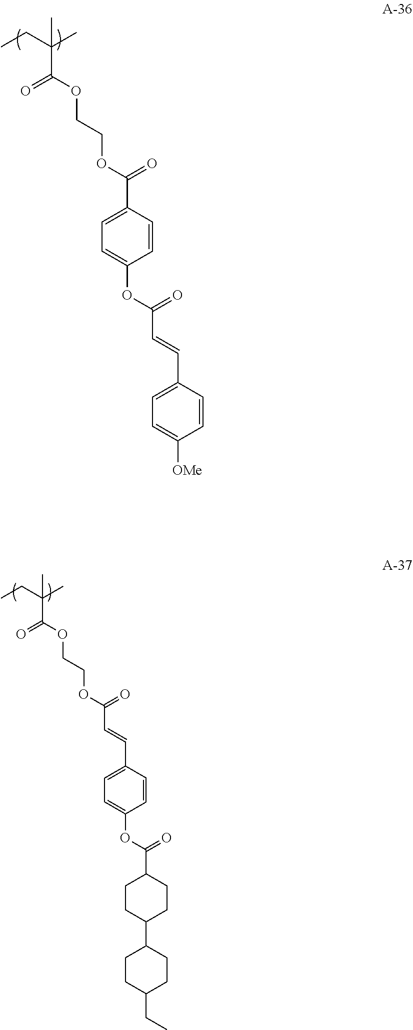

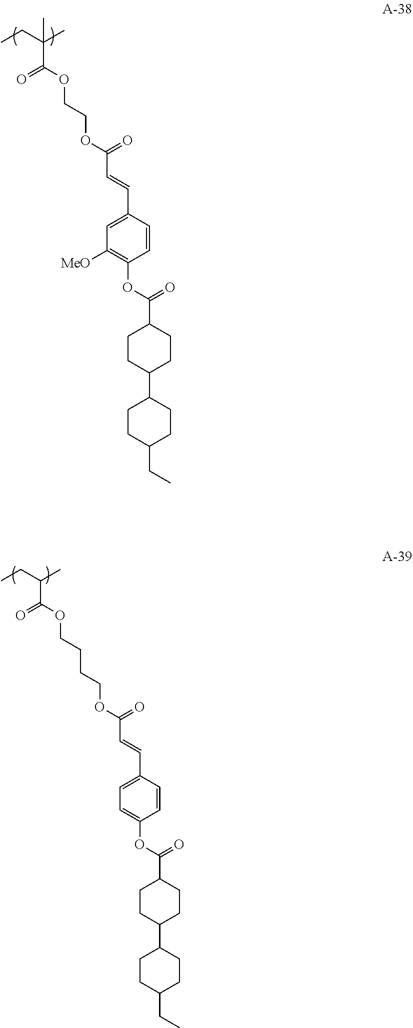

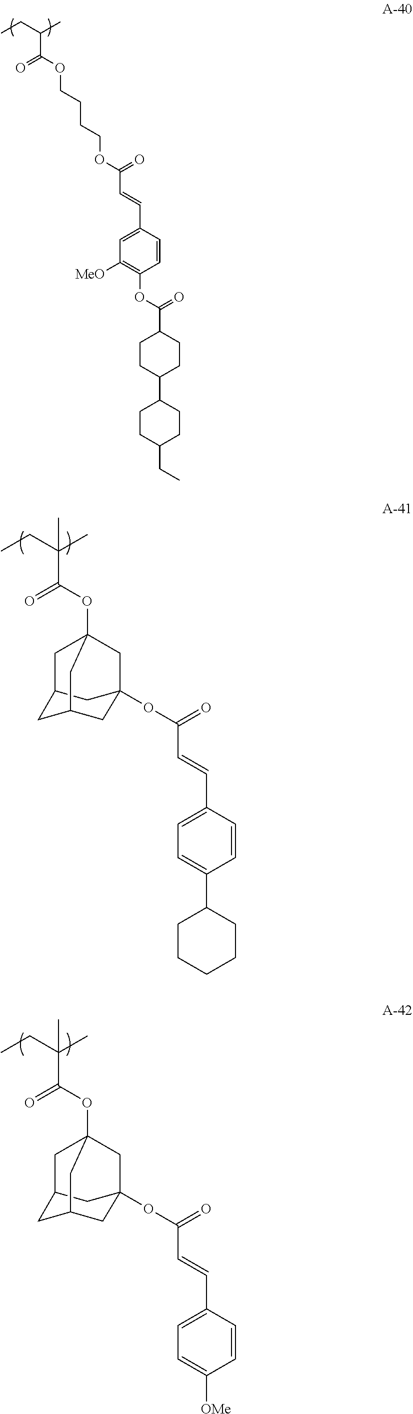

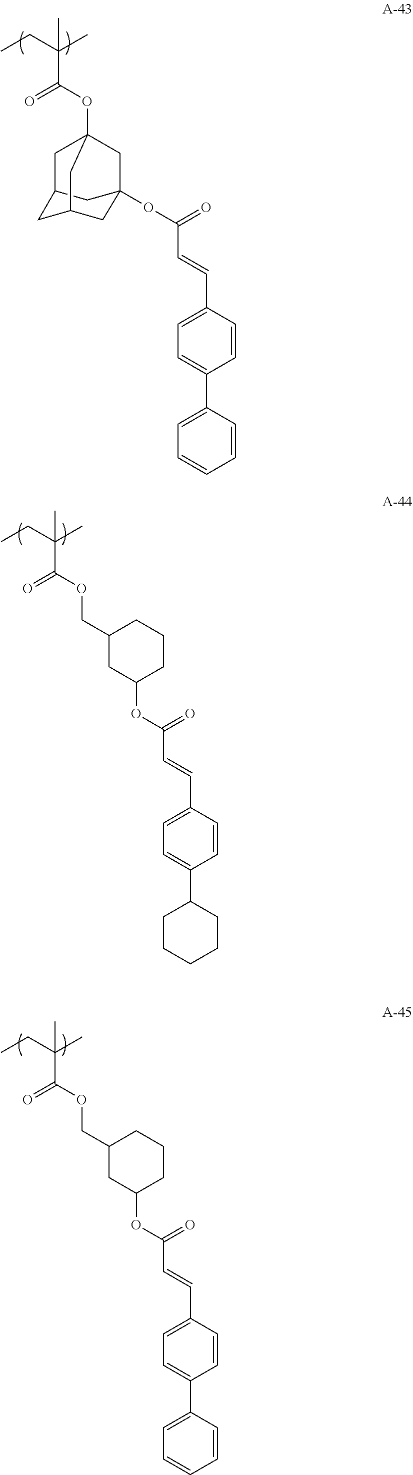

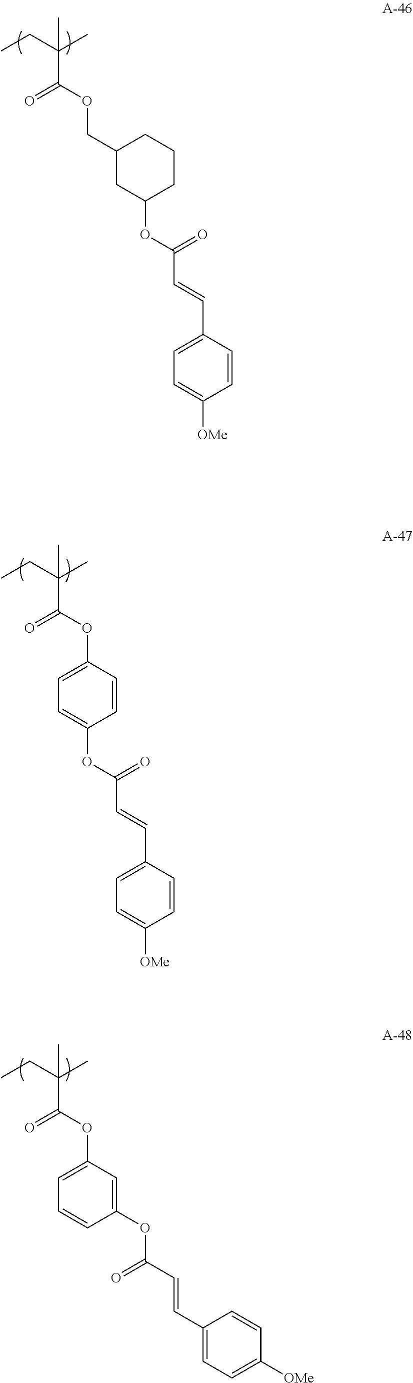

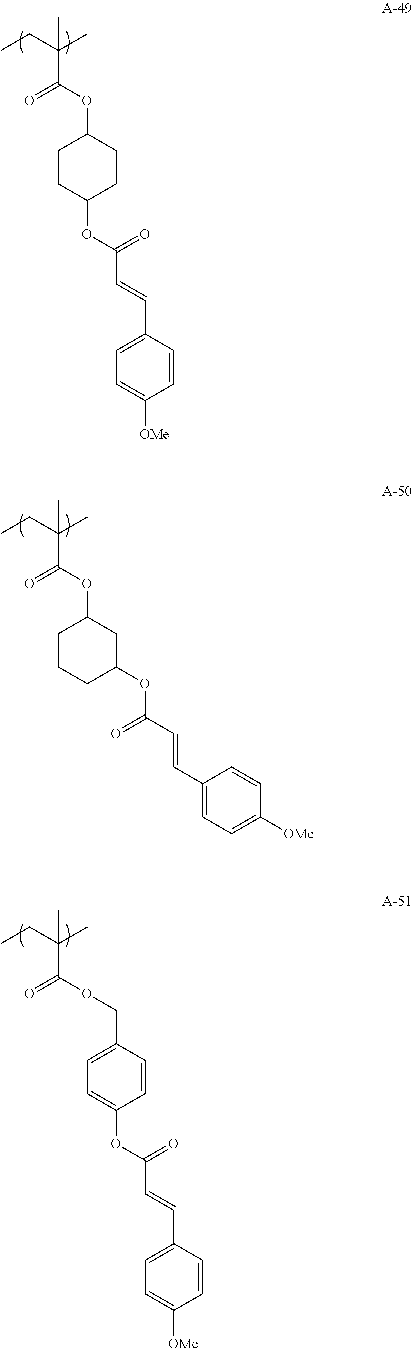

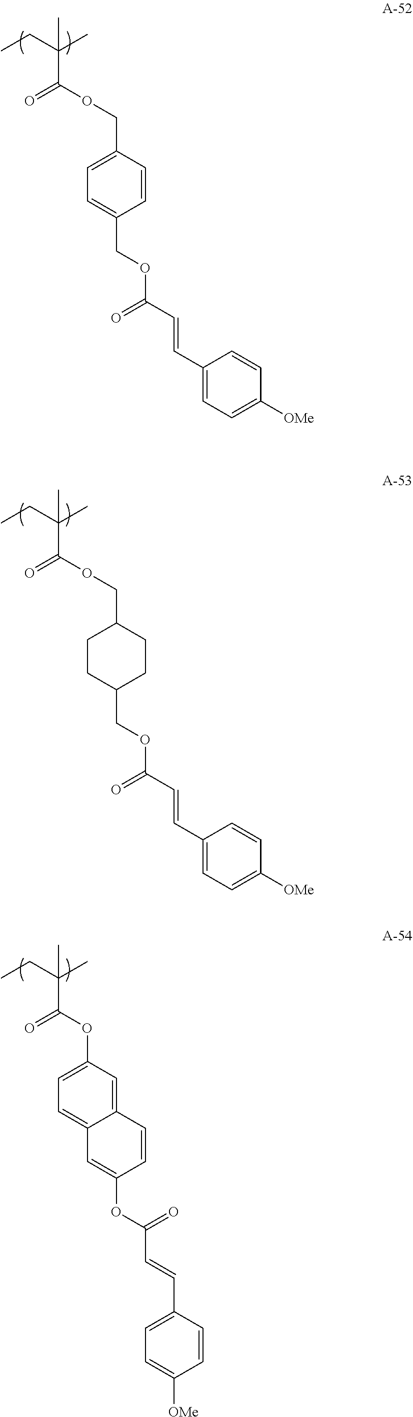

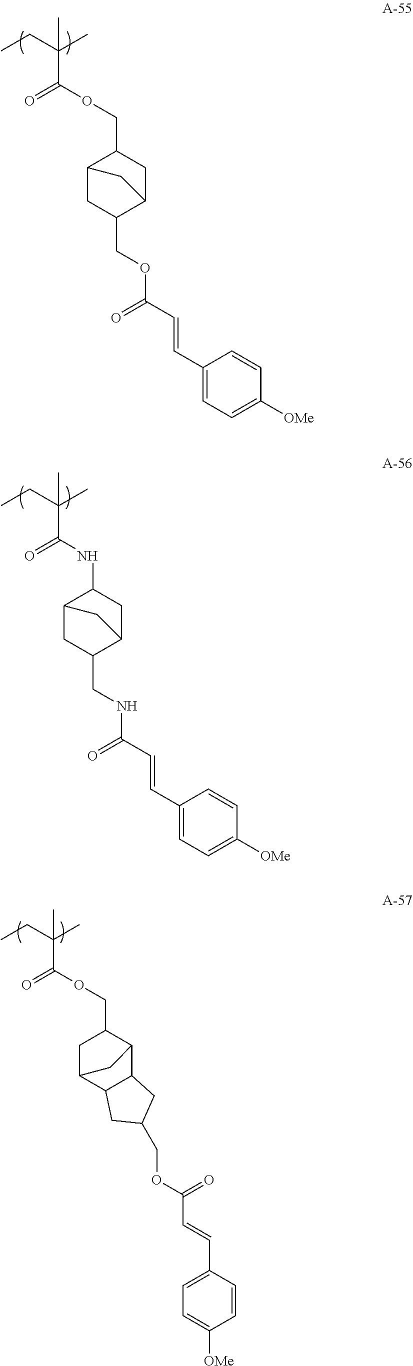

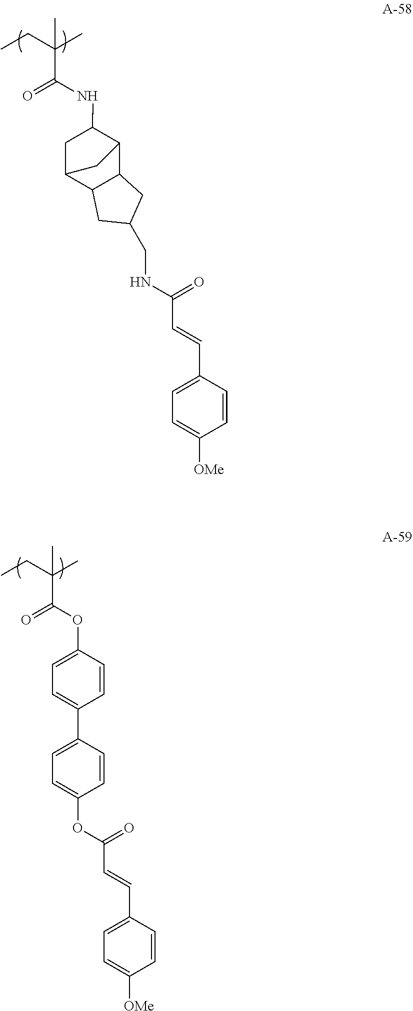

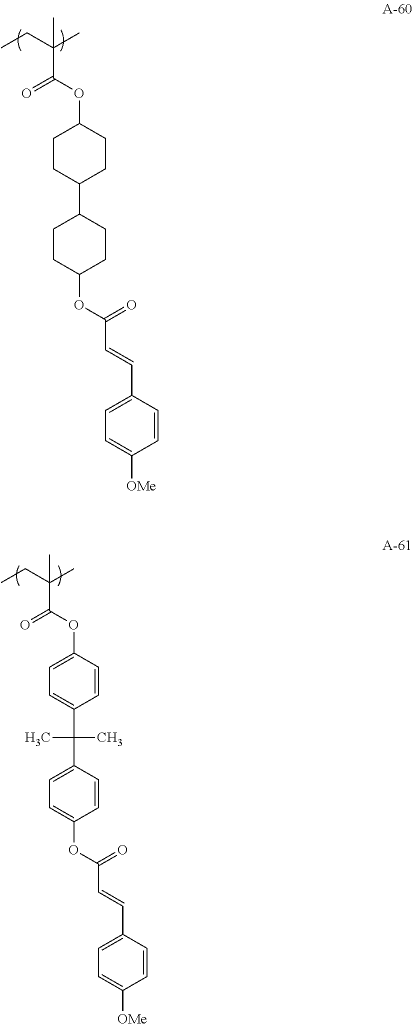

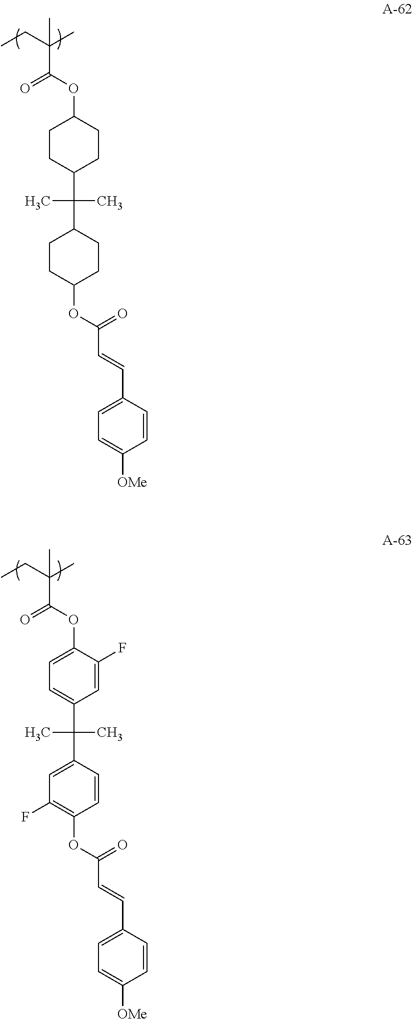

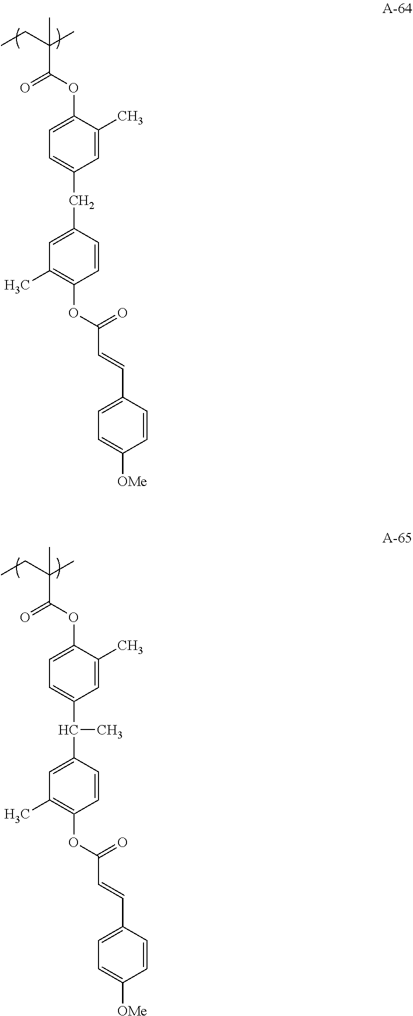

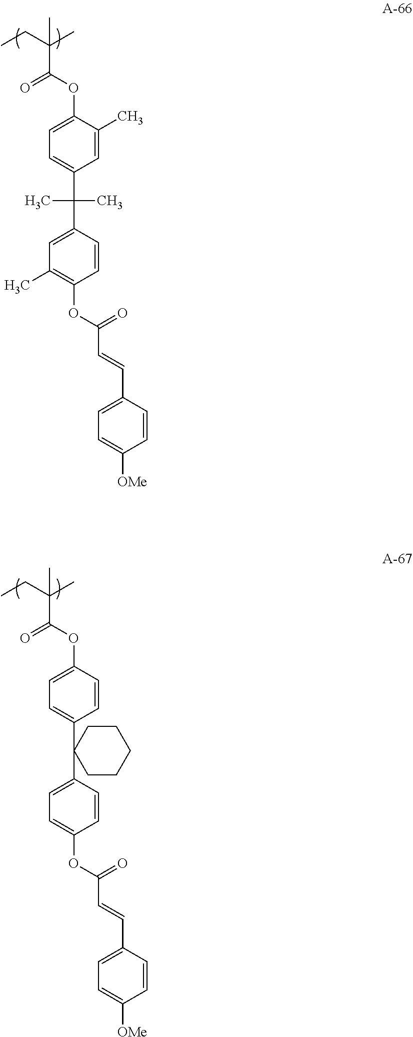

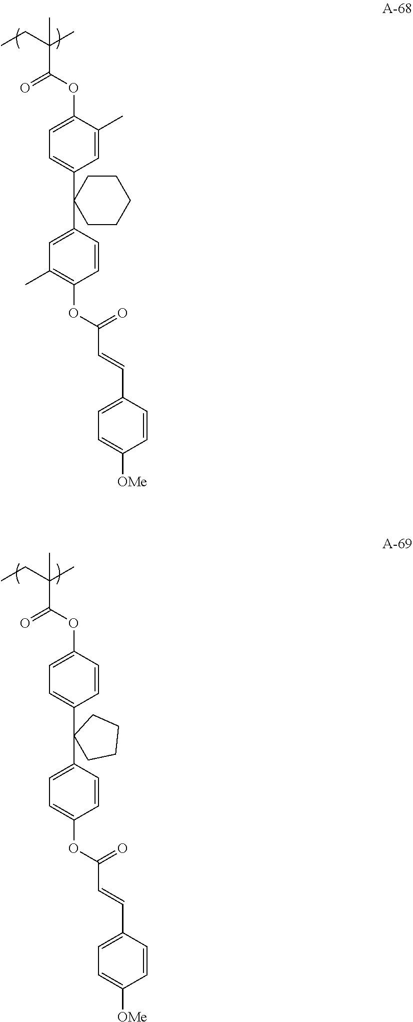

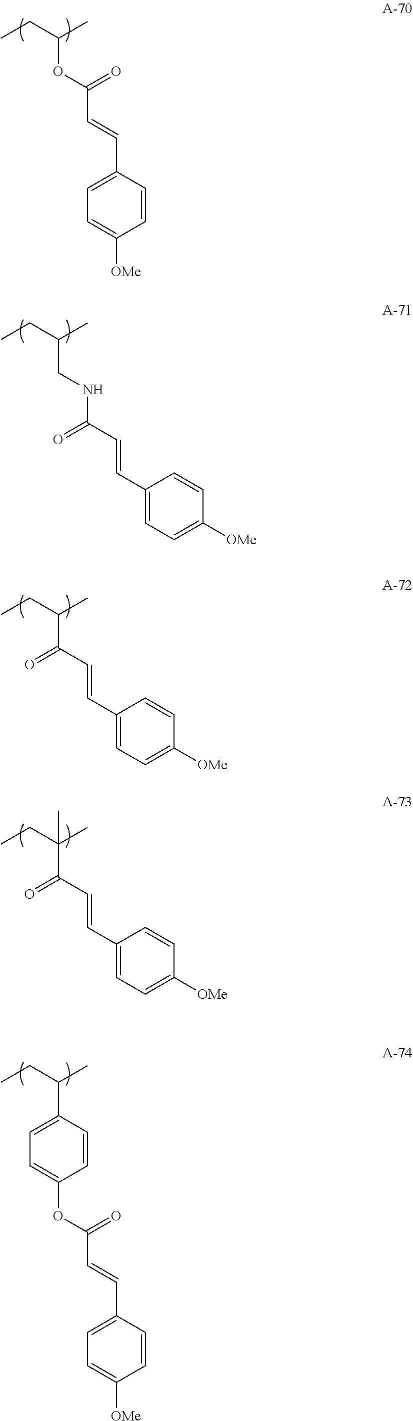

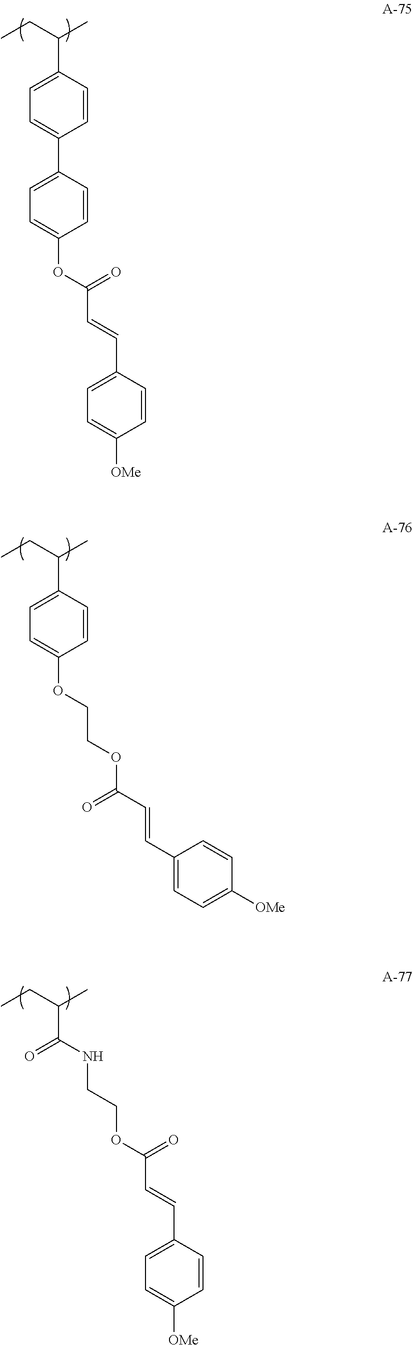

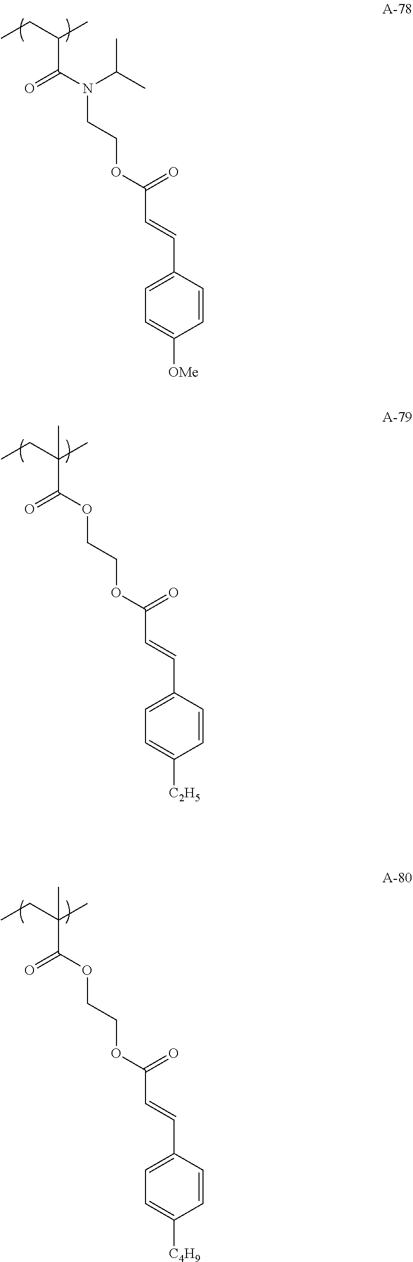

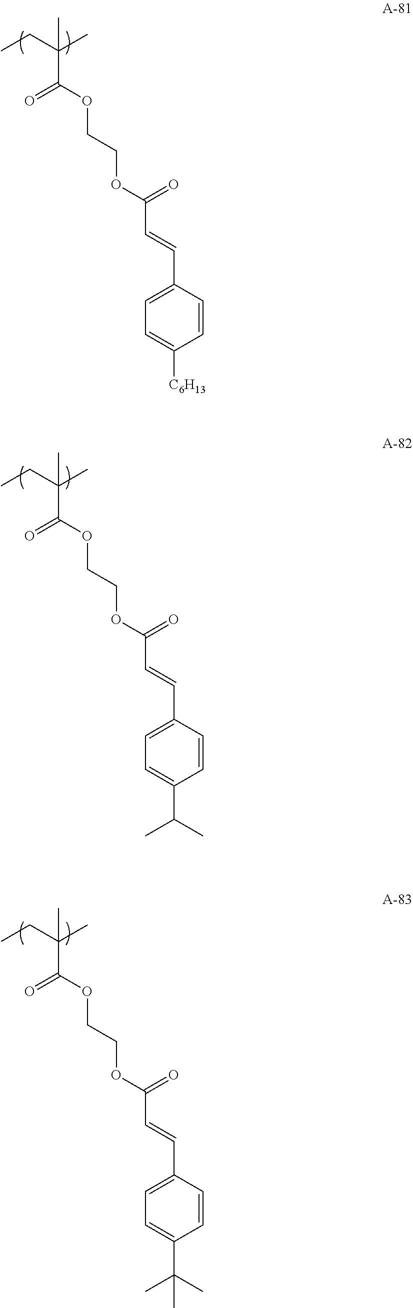

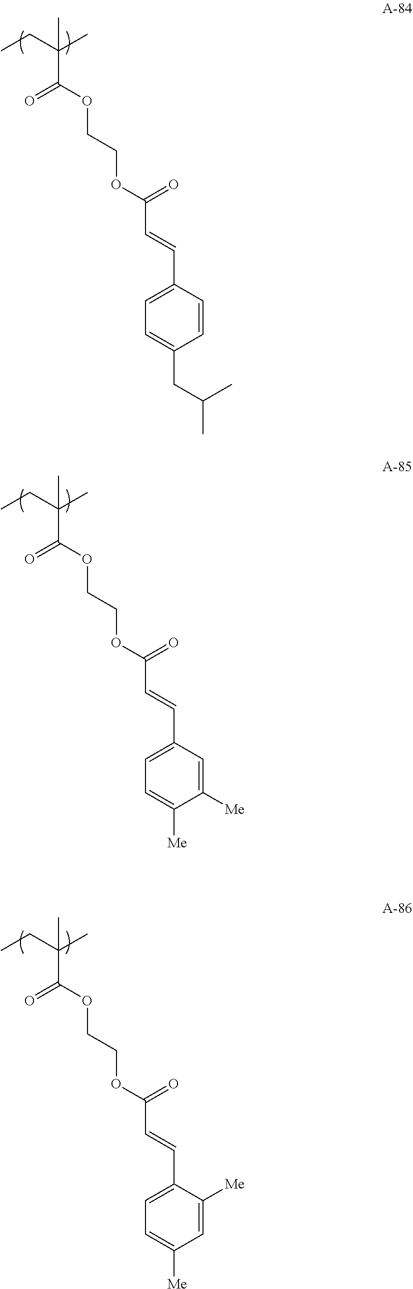

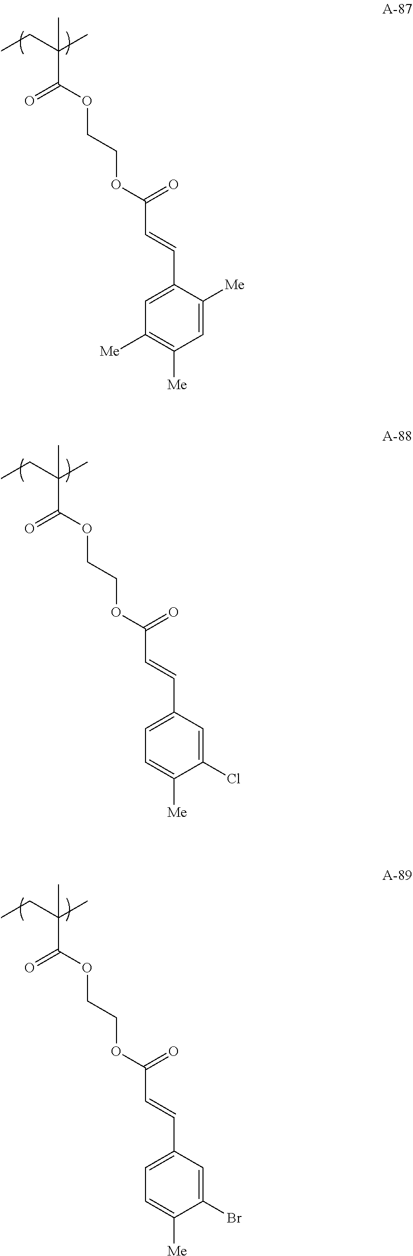

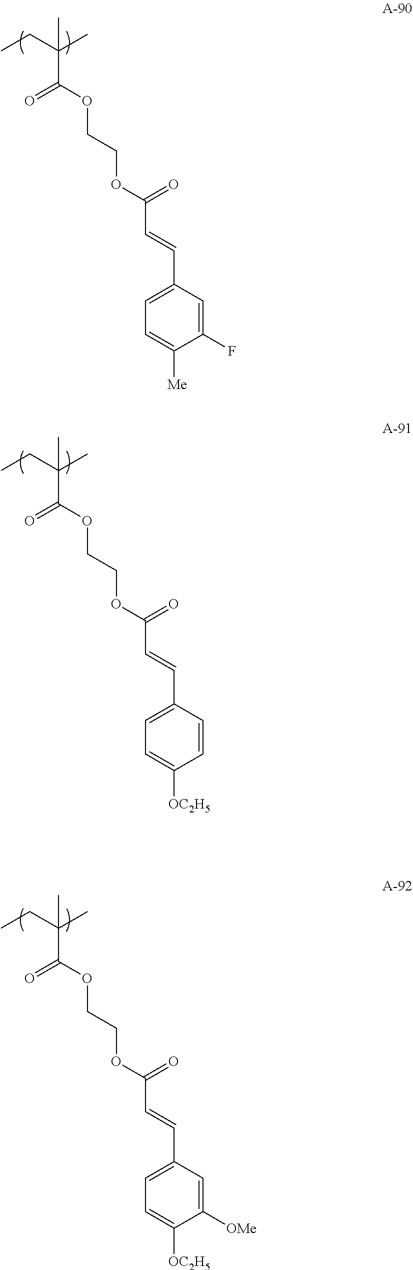

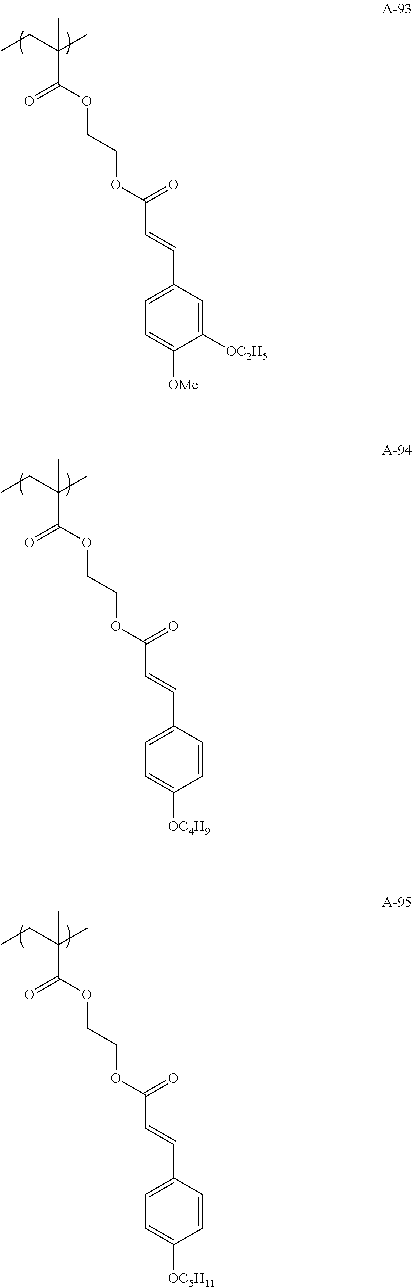

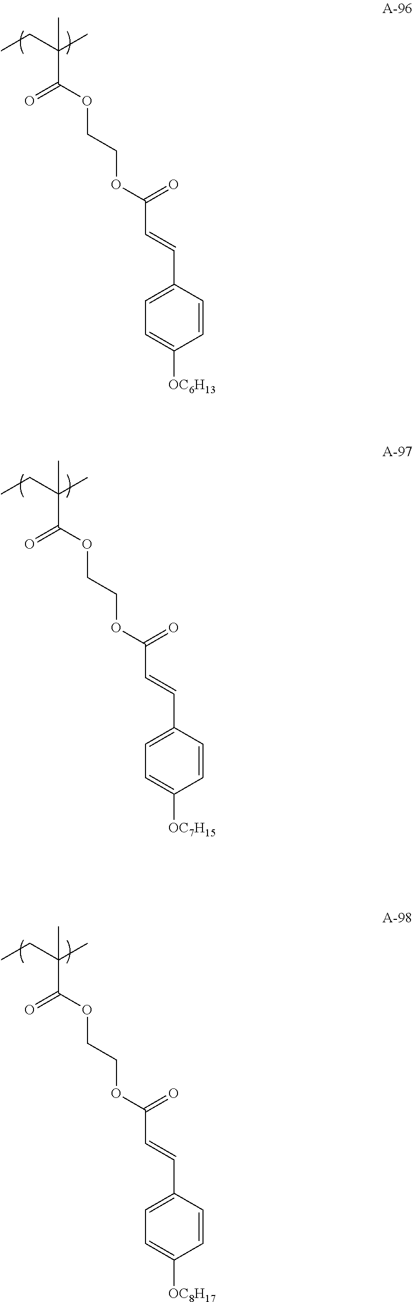

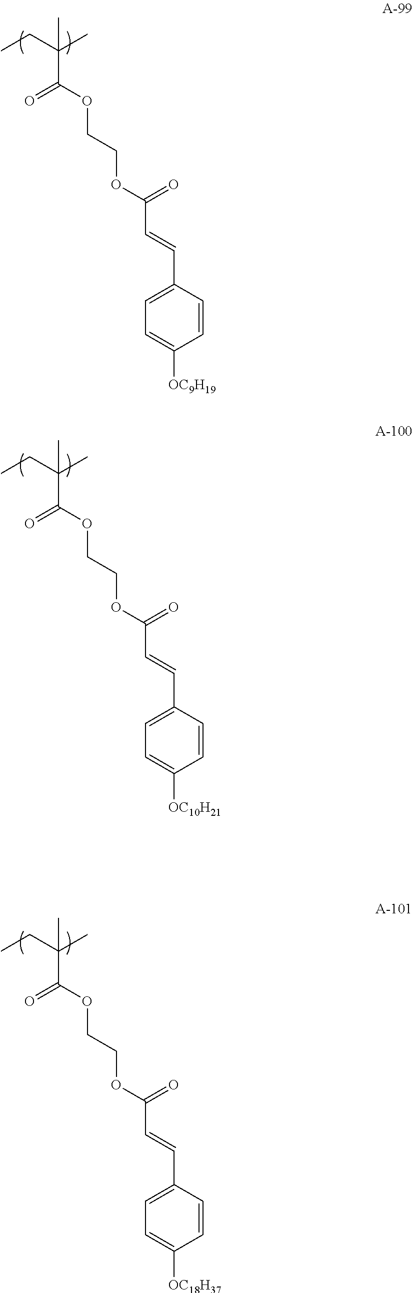

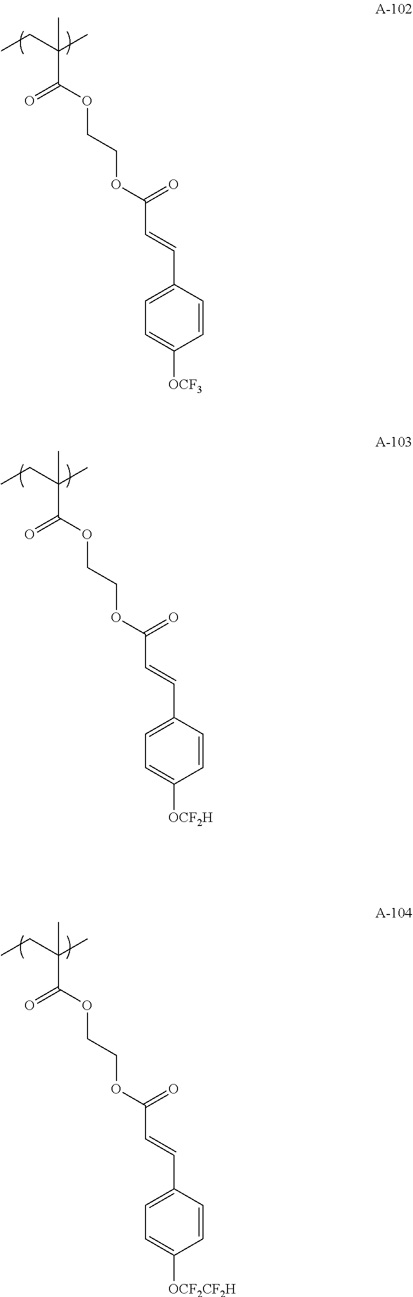

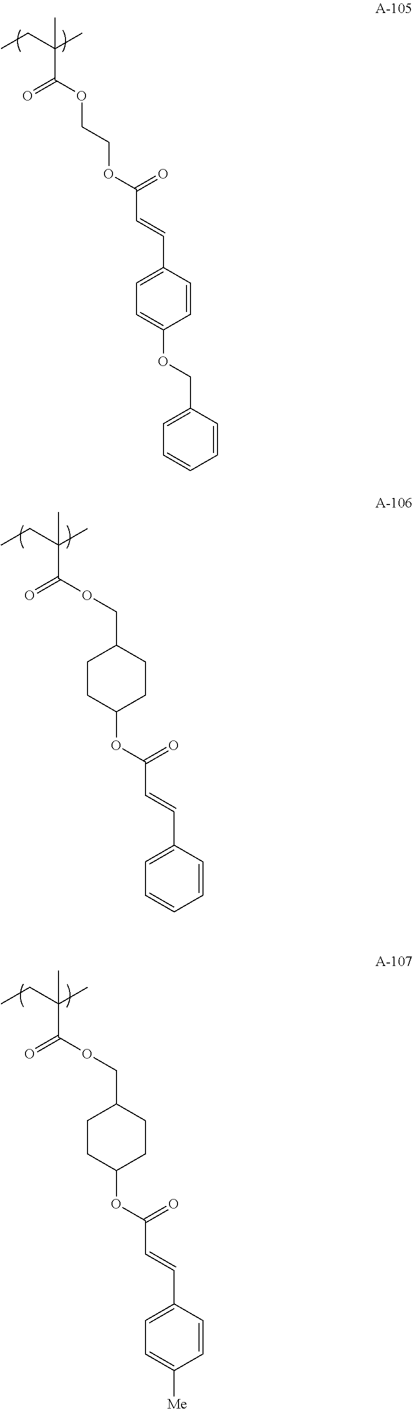

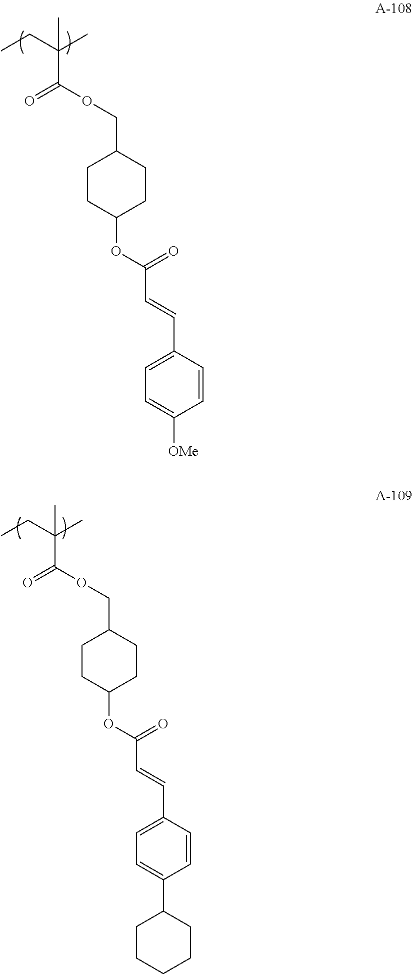

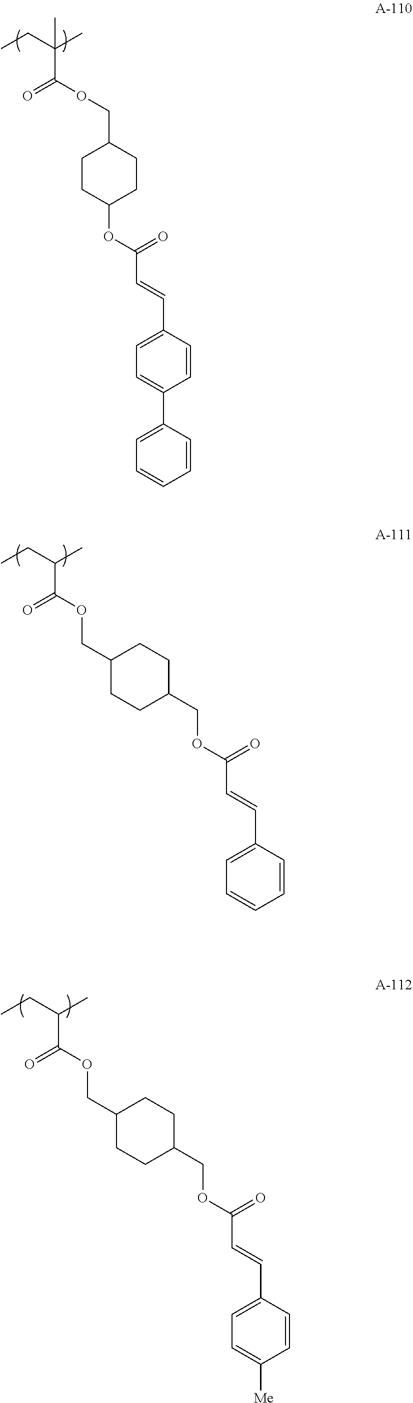

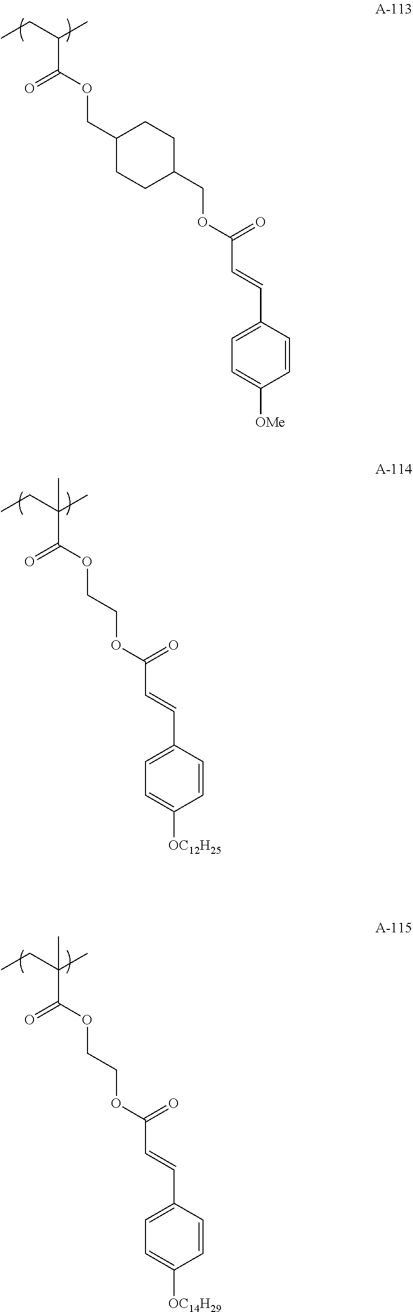

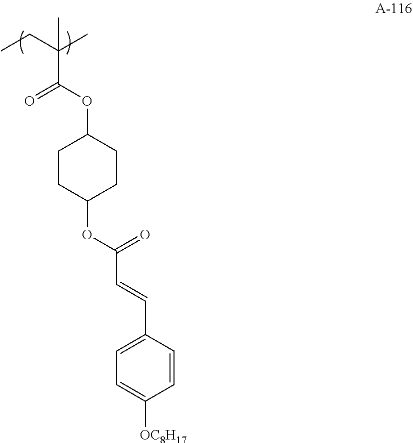

Specific examples of the repeating unit B including a photo-alignment group represented by Formula (2) include repeating units B-1 to B-16 shown below.

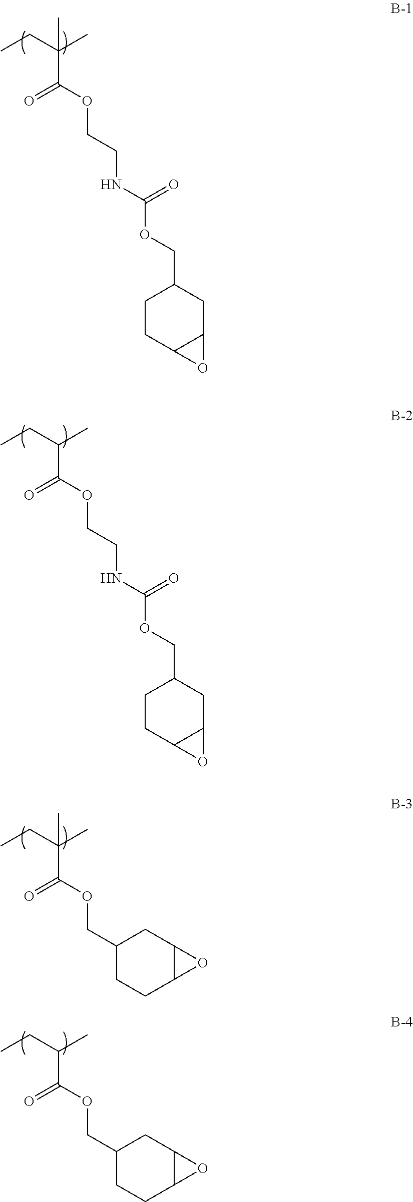

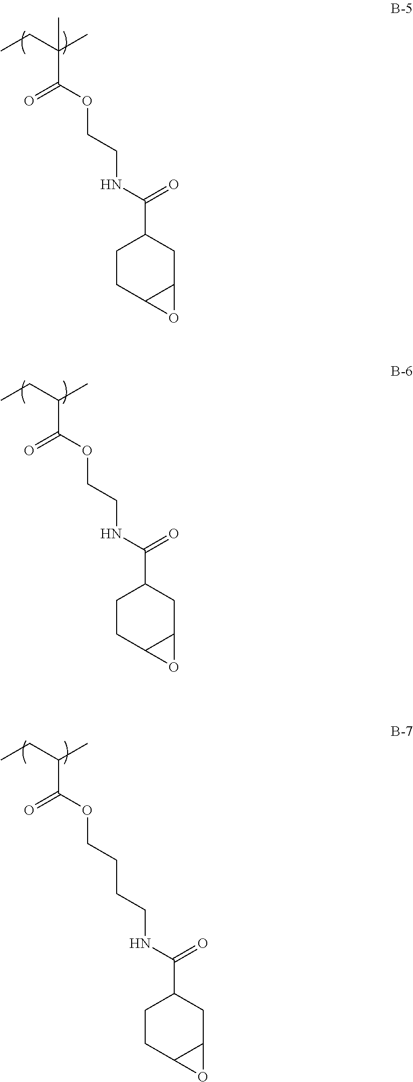

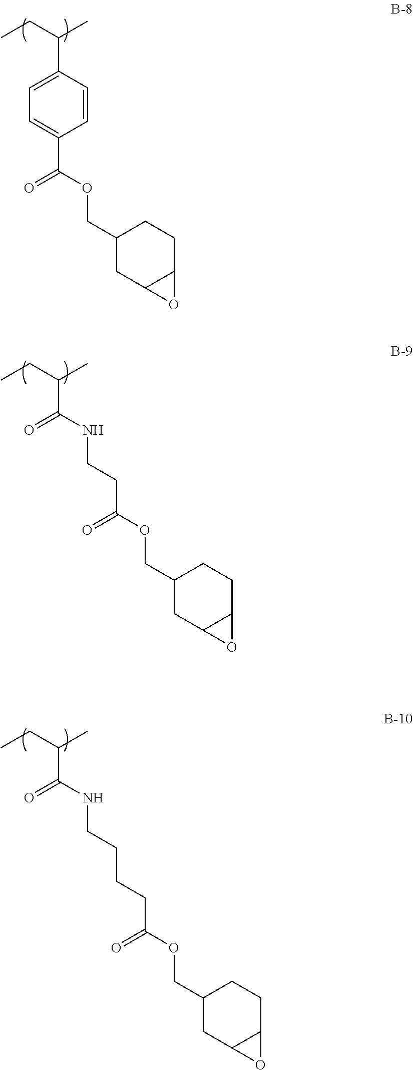

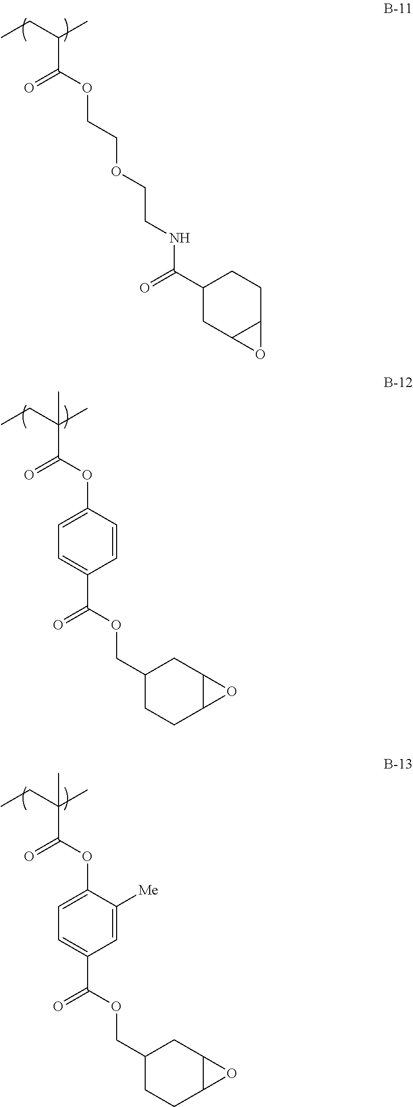

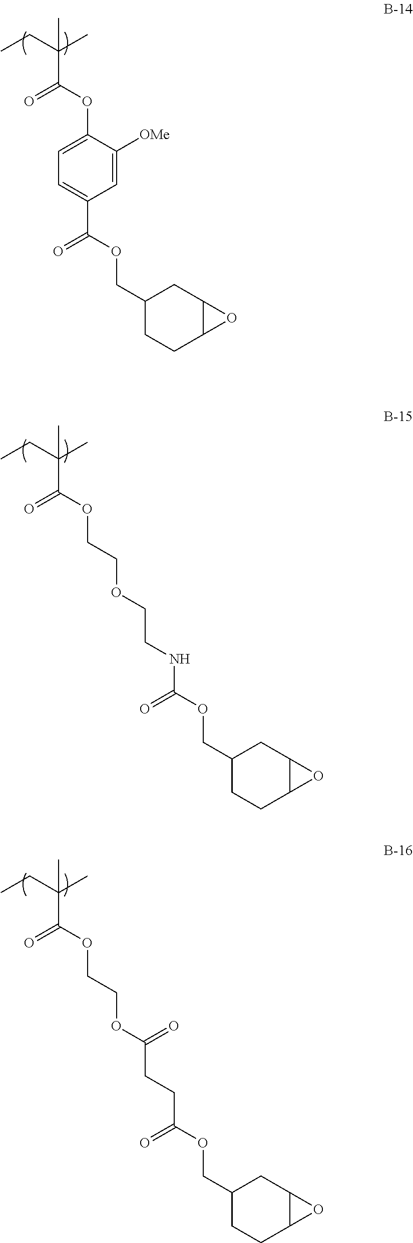

In the photo-alignment copolymer according to the embodiment of the invention, a content X of the above-described repeating unit A and a content Y of the above-described repeating unit B preferably satisfy Formula (4), more preferably satisfy Formula (5), and even more preferably satisfy Formula (7) since the rigidity of the photo-alignment copolymer to be obtained is improved, and the heat resistance of a photo-alignment film to be produced is further improved.

0.2≤X/(X+Y)≤0.8 (4)

0.2≤X/(X+Y)≤6 (5)

0.3≤X/(X+Y)≤0.5 (7)

The photo-alignment copolymer according to the embodiment of the invention may have other repeating units other than the repeating unit A and the repeating unit B described above, as long as the effects of the invention are not impaired.

Examples of the monomers (radically polymerizable monomers) forming other repeating units include an acrylic acid ester compound, a methacrylic acid ester compound, a maleimide compound, an acrylamide compound, acrylonitrile, maleic anhydride, a styrene compound, and a vinyl compound.

Specifically, the photo-alignment copolymer according to the embodiment of the invention preferably has a repeating unit C represented by Formula (6) from the viewpoint of improving the liquid crystal aligning properties at a low exposure dose. The reason for this is thought to be that the repeating unit C reacts with the crosslinkable group in the above-described repeating unit B and makes the crosslinking, thereby supporting the crosslinking by the repeating unit B.

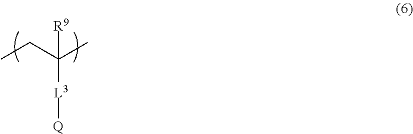

In Formula (6), R⁹ represents a hydrogen atom or a methyl group.

In Formula (6), L³ represents a divalent linking group formed by one group or combining one or more groups selected from the group consisting of a linear, branched, or cyclic alkylene group having 1 to 10 carbon atoms and optionally having the substituent A, an arylene group having 6 to 12 carbon atoms and optionally having the substituent B, an ether group, a carbonyl group, and an imino group optionally having the substituent C.

In Formula (6), Q represents any group of —OH, —COOH, and —COOtBu. “tBu” is an abbreviation for tert-butyl.

Specific examples of the repeating unit C represented by Formula (6) include the following repeating units C-1 to C-12.

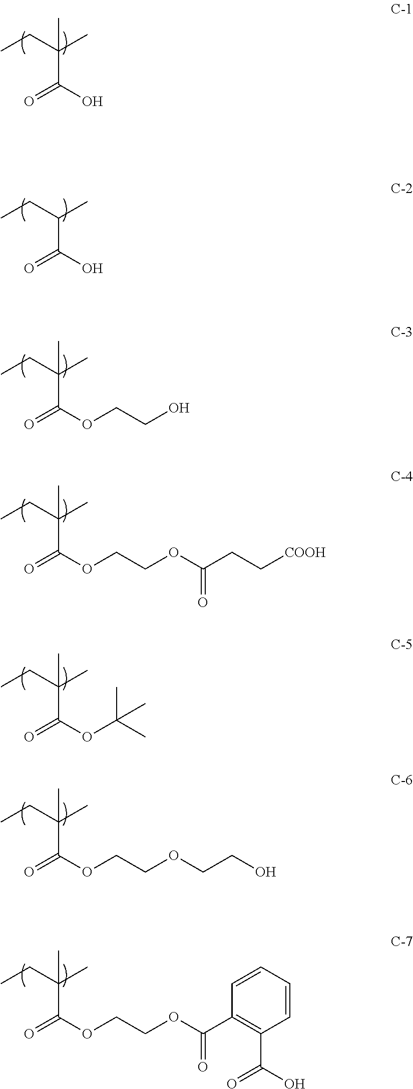

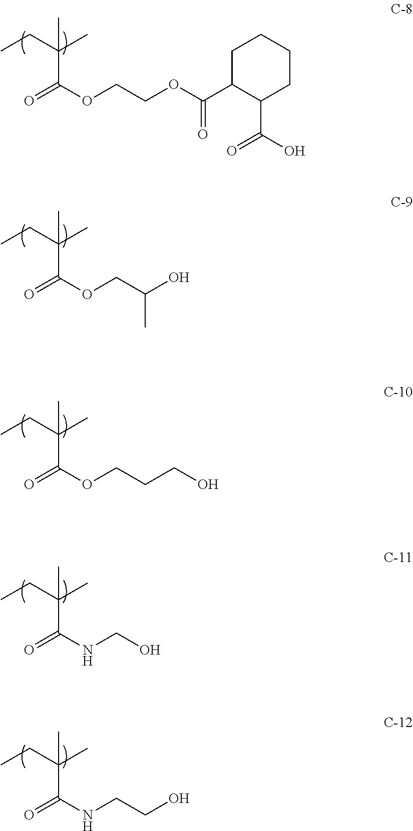

The method of synthesizing the photo-alignment copolymer according to the embodiment of the invention is not particularly limited. For example, the photo-alignment copolymer can be synthesized by mixing a monomer forming the above-described repeating unit A, a monomer forming the above-described repeating unit B, and monomers forming other optional repeating units (for example, the above-described repeating unit C) and polymerizing the monomers using a radical polymerization initiator in an organic solvent.

The weight-average molecular weight (Mw) of the photo-alignment copolymer according to the embodiment of the invention is preferably 10,000 to 500,000 since the rigidity of the photo-alignment copolymer to be obtained is improved, and the heat resistance of a photo-alignment film to be produced is further improved. In addition, the weight-average molecular weight is more preferably 30,000 to 200,000 since the liquid crystal aligning properties are improved.

Here, in the invention, the weight-average molecular weight and the number-average molecular weight are values measured by gel permeation chromatography (GPC) under the following conditions.
Solvent (eluent): Tetrahydrofuran (THF)
Device Name: TOSOH HLC-8320GPC
Column: Three columns of TOSOH TSKgel Super HZM-H (4.6 mm×15 cm)) are connected and used.
Column Temperature: 40° C.
Sample Concentration: 0.1 mass %
Flow Rate: 1.0 ml/min
Calibration Curve: A calibration curve made by 7 samples of TSK standard polystyrene manufactured by TOSOH Corporation, Mw of which is 2,800,000 to 1,050 (Mw/Mn=1.03 to 1.06), is used.

[Photo-Alignment Film]

A photo-alignment film according to the embodiment of the invention is a photo-alignment film formed using a photo-alignment film composition (hereinafter, also formally referred to as “photo-alignment film composition according to the invention”) containing the above-described photo-alignment copolymer according to the embodiment of the invention.

The thickness of the photo-alignment film is not particularly limited, and can be appropriately selected according to the purpose. The thickness of the photo-alignment copolymer is preferably 10 to 1,000 nm, and more preferably 10 to 700 nm.

The content of the photo-alignment copolymer according to the embodiment of the invention in the photo-alignment film composition according to the invention is not particularly limited. In a case where an organic solvent to be described later is contained, the content of the photo-alignment copolymer is preferably 0.1 to 50 parts by mass, and more preferably 0.5 to 10 parts by mass with respect to 100 parts by mass of the organic solvent.

The photo-alignment film composition according to the invention preferably contains an organic solvent from the viewpoint of workability or the like for producing a photo-alignment film.

Specific examples of the organic solvent include ketones (for example, acetone, 2-butanone, methyl isobutyl ketone, cyclohexanone, and cyclopentanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethyl acetamide). These may be used alone or in combination of two or more kinds thereof.

The photo-alignment film composition according to the invention may contain components other than the above components, and examples thereof include a crosslinking catalyst, an adhesion enhancing agent, a leveling agent, a surfactant, and a plasticizer.

[Photo-Alignment Film Manufacturing Method]

The photo-alignment film according to the embodiment of the invention can be manufactured by a manufacturing method which has been known, except that the above-described photo-alignment film composition according to the invention is used. For example, the photo-alignment film can be manufactured by a manufacturing method having a coating step of coating the above-described photo-alignment film composition according to the invention on a surface of a support and a light irradiation step of irradiating a surface of the coating film of the photo-alignment film composition with polarized or unpolarized light in an oblique direction.

The support will be described in the description of an optical laminate according to the embodiment of the invention to be described later.

<Coating Step>

In the coating step, the coating method is not particularly limited, and can be appropriately selected according to the purpose. Examples thereof include spin coating, die coating, gravure coating, flexographic printing, and inkjet printing.

<Light Irradiation Step>

In the light irradiation step, the polarized light which is irradiated on the coating film of the photo-alignment film composition is not particularly limited. Examples thereof include linearly polarized light, circularly polarized light, and elliptically polarized light, and among these, linearly polarized light is preferable.

The “oblique direction” in which irradiation with unpolarized light is performed is not particularly limited as long as it is a direction inclined at a polar angle θ (0°<θ<90°) with respect to a normal direction of the surface of the coating film. 0 can be appropriately selected according to the purpose, and is preferably 20° to 80°.

The wavelength of polarized light or unpolarized light is not particularly limited as long as a capability of controlling alignment of liquid crystalline molecules can be imparted to the coating film of the photo-alignment film composition. For example, ultraviolet rays, near-ultraviolet rays, visible rays, or the like are used. Among these, near-ultraviolet rays with a wavelength of 250 nm to 450 nm are particularly preferable.

Examples of the light source for the irradiation with polarized light or unpolarized light include a xenon lamp, a high-pressure mercury lamp, an extra-high-pressure mercury lamp, and a metal halide lamp. By using an interference filter, a color filter, or the like with respect to ultraviolet rays or visible rays obtained from the light source, the wavelength range of the irradiation can be restricted. In addition, linearly polarized light can be obtained by using a polarization filter or a polarization prism with respect to the light from the light source.

The integrated light quantity of polarized light or unpolarized light is not particularly limited as long as a capability of controlling alignment of liquid crystalline molecules can be imparted to the coating film of the photo-alignment film composition. The integrated light quantity is preferably 1 to 300 mJ/cm², and more preferably 5 to 100 mJ/cm².

The illuminance of polarized light or unpolarized light is not particularly limited as long as a capability of controlling alignment of liquid crystalline molecules can be imparted to the coating film of the photo-alignment film composition. The illuminance is preferably 0.1 to 300 mW/cm², and more preferably 1 to 100 mW/cm².

[Optical Laminate]

An optical laminate according to the embodiment of the invention is an optical laminate which has the above-described photo-alignment film according to the embodiment of the invention and an optically anisotropic layer formed using a liquid crystal composition containing a liquid crystal compound.

The optical laminate according to the embodiment of the invention preferably further has a support. Specifically, the optical laminate preferably has the support, the photo-alignment film, and the optically anisotropic layer in this order.

[Optically Anisotropic Layer]

The optically anisotropic layer of the optical laminate according to the embodiment of the invention is not particularly limited as long as it is an optically anisotropic layer containing a liquid crystal compound. An optically anisotropic layer which has been known can be appropriately employed and used.

Such an optically anisotropic layer is preferably a layer obtained by curing a composition containing a liquid crystal compound having a polymerizable group (hereinafter, also referred to as “optically anisotropic layer forming composition”). The optically anisotropic layer may have a single layer structure or a structure including a lamination of a plurality of layers (laminate).

Hereinafter, a liquid crystal compound and predetermined additives contained in the optically anisotropic layer forming composition will be described.

<Liquid Crystal Compound>

The liquid crystal compound contained in the optically anisotropic layer forming composition is a liquid crystal compound having a polymerizable group.

In general, liquid crystal compounds can be classified into a rod-like type and a disk-like type according to the shape thereof. Further, each type includes a low molecular type and a high molecular type. The term high molecular generally refers to a compound having a degree of polymerization of 100 or greater (Polymer Physics-Phase Transition Dynamics, written by Masao Doi, p. 2, published by Iwanami Shoten, 1992).

In the invention, any type of liquid crystal compound can be used, but a rod-like liquid crystal compound or a discotic liquid crystal compound is preferably used, and a rod-like liquid crystal compound is more preferably used.

In the invention, in order to fix the above-described liquid crystal compound, a liquid crystal compound having a polymerizable group is used, and it is preferable that the liquid crystal compound has two or more polymerizable groups in one molecule. In a case where a mixture of two or more kinds of liquid crystal compounds is used, at least one liquid crystal compound preferably has two or more polymerizable groups in one molecule. After the fixing of the liquid crystal compound by polymerization, it is not necessary for the compound to exhibit crystallinity.

The kind of the polymerizable group is not particularly limited. A functional group allowing an addition polymerization reaction is preferable, and a polymerizable ethylenically unsaturated group is more preferable. More specifically, preferable examples thereof include a (meth)acryloyl group, a vinyl group, a styryl group, and an allyl group, and a (meth)acryloyl group is more preferable. A (meth)acryloyl group means both of a methacryloyl group and an acryloyl group.

As the rod-like liquid crystal compound, for example, those described in claim 1 of JP1999-513019A (JP-H11-513019A) or paragraphs <0026> to <0098> of JP2005-289980A can be preferably used, and as the discotic liquid crystal compound, for example, those described in paragraphs <0020> to <0067> of JP2007-108732A or paragraphs <0013> to <0108> of JP2010-244038A can be preferably used, but the liquid crystal compounds are not limited thereto.

In the invention, as the liquid crystal compound, a liquid crystal compound having reciprocal wavelength dispersibility can be used.

Here, in this specification, the liquid crystal compound having “reciprocal wavelength dispersibility” refers to the fact that in the measurement of an in-plane retardation (Re) value at a specific wavelength (visible light range) of a retardation film produced using the liquid crystal compound, as the measurement wavelength increases, the Re value becomes equal or higher.

The liquid crystal compound having reciprocal wavelength dispersibility is not particularly limited as long as a film having reciprocal wavelength dispersibility can be formed as described above, and for example, compounds represented by Formula (I) described in JP2008-297210A (particularly, compounds described in paragraphs <0034> to <0039>), compounds represented by Formula (1) described in JP2010-084032A (particularly, compounds described in paragraphs <0067> to <0073>), and compounds represented by Formula (1) described in JP2016-081035A (particularly, compounds described in paragraphs <0043> to <0055>) can be used.

<Additives>

The optically anisotropic layer forming composition may include a compound other than the above-described liquid crystal compound.

For example, the optically anisotropic layer forming composition may include a polymerization initiator. A polymerization initiator to be used is selected according to the form of the polymerization reaction, and examples thereof include a thermal polymerization initiator and a photopolymerization initiator. Examples of the photopolymerization initiator include α-carbonyl compound, acyloin ether, α-hydrocarbon-substituted aromatic acyloin compound, polynuclear quinone compound, and combination of triaryl imidazole dimer and p-aminophenyl ketone.

The amount of the polymerization initiator to be used is preferably 0.01 to 20 mass %, and more preferably 0.5 to 5 mass % with respect to the total solid content of the composition.

The optically anisotropic layer forming composition may contain a polymerizable monomer in view of the uniformity of the coating film and the hardness of the film.

Examples of the polymerizable monomer include a radical polymerizable or cation polymerizable compound. A polyfunctional radical polymerizable monomer is preferable, and the polymerizable monomer is more preferably copolymerizable with the above-described liquid crystal compound containing a polymerizable group. Examples thereof include those described in paragraphs <0018> to <0020> of JP2002-296423A.

The content of the polymerizable monomer is preferably 1 to 50 mass %, and more preferably 2 to 30 mass % with respect to the total mass of the liquid crystal compound.

The optically anisotropic layer forming composition may contain a surfactant in view of the uniformity of the coating film and the hardness of the film.

Examples of the surfactant include compounds which have been known, and a fluorine-based compound is particularly preferable. Specific examples thereof include compounds described in paragraphs <0028> to <0056> of JP2001-330725A and compounds described in paragraphs <0069> to <0126> of JP2005-062673A.

The optically anisotropic layer forming composition may contain an organic solvent. Examples of the organic solvent include those described in the above description of the photo-alignment film composition according to the invention.

The optically anisotropic layer forming composition may contain various alignment agents such as vertical alignment accelerators, e.g., polarizer interface-side vertical alignment agents and air interface-side vertical alignment agents, and horizontal alignment accelerators, e.g., polarizer interface-side horizontal alignment agents and air interface-side horizontal alignment agents.

The optically anisotropic layer forming composition may further contain an adhesion enhancing agent, a plasticizer, a polymer, or the like other than the above-described components.

The method of forming an optically anisotropic layer using an optically anisotropic layer forming composition having the above components is not particularly limited. For example, a coating film may be formed by coating an optically anisotropic layer forming composition on the above-described photo-alignment film according to the embodiment of the invention, and the obtained coating film may be subjected to a curing treatment (irradiation with ultraviolet rays (light irradiation treatment) or heating treatment) to form an optically anisotropic layer.

The coating with the optically anisotropic layer forming composition is performed by a known method (for example, wire bar coating method, extrusion coating method, direct gravure coating method, reverse gravure coating method, or die coating method).

In the invention, the thickness of the optically anisotropic layer is not particularly limited. The thickness is preferably 0.1 to 10 μm, and more preferably 0.5 to 5 μm.

[Support]

The optical laminate according to the embodiment of the invention may have a support as a base for forming the optically anisotropic layer as described above.

Examples of such a support include a polarizer and a polymer film, and further include a combination thereof, such as a laminate of a polarizer and a polymer film and a laminate of a polymer film, a polarizer, and a polymer film.

The support may be a temporary support which is peelable after formation of the optically anisotropic layer (hereinafter, may be simply referred to as “temporary support”). Specifically, a polymer film functioning as a temporary support may be peeled off from the optical laminate to provide the optically anisotropic layer. For example, an optical laminate including an optically anisotropic layer and a temporary support may be prepared, the optically anisotropic layer side of the optical laminate may be bonded to a support including a polarizer with a pressure sensitive adhesive or an adhesive, and then the temporary support included in the optically anisotropic layer may be peeled off to provide a laminate of the support including a polarizer and the optically anisotropic layer.

<Polarizer>

In the invention, in a case where the optical laminate according to the embodiment of the invention is used in an image display device, at least a polarizer is preferably used as a support.

The polarizer is not particularly limited as long as it is a member functioning to convert light into specific linearly polarized light. An absorption-type polarizer or a reflection-type polarizer which has been known can be used.

As the absorption-type polarizer, an iodine-based polarizer, a dye-based polarizer using a dichroic dye, a polyene-based polarizer, or the like is used. The iodine-based polarizer and the dye-based polarizer include a coating-type polarizer and a stretching-type polarizer, and any of these may be applicable. A polarizer produced by adsorbing iodine or a dichroic dye to polyvinyl alcohol and performing stretching is preferable.

Examples of the method of obtaining a polarizer by performing stretching and dyeing in a state in which a lamination film is obtained by forming a polyvinyl alcohol layer on a base include JP5048120B, JP5143918B, JP5048120B, JP4691205B, JP4751481B, and JP4751486B. These known technologies concerning a polarizer can also be preferably used.

As the reflection-type polarizer, a polarizer obtained by laminating thin films having different birefringences, a wire grid-type polarizer, a polarizer obtained by combining a cholesteric liquid crystal having a selective reflection area and a ¼ wavelength plate, or the like is used.

Among these, a polarizer including a polyvinyl alcohol-based resin (that means a polymer including —CH₂—CHOH— as a repeating unit. Particularly, at least one selected from the group consisting of polyvinyl alcohol and ethylene-vinyl alcohol copolymer is preferable) is preferable in view of handleability.

In an aspect in which the optical laminate according to the embodiment of the invention includes a peelable support, a polarizing plate can be manufactured as follows.

The support is peeled off from the above-described optical laminate, and a layer including an optically anisotropic layer is laminated on a support including a polarizer. Otherwise, the above-described optical laminate is laminated on a support including a polarizer, and then the peelable support included in the optical laminate is peeled off. During the lamination, both layers may be adhered using an adhesive or the like. The adhesive is not particularly limited, and examples thereof include a curable adhesive of an epoxy compound including no aromatic ring in the molecule as shown in JP2004-245925A, an active energy ray-curable adhesive containing, as essential components, a photopolymerization initiator having a molar absorption coefficient of 400 or greater at a wavelength of 360 to 450 nm and an ultraviolet-curable compound as described in JP2008-174667A, and an active energy ray-curable adhesive containing (a) (meth)acrylic compound having two or more (meth)acryloyl groups in the molecule, (b) (meth)acrylic compound having a hydroxyl group in the molecule and having only one polymerizable double bond, and (c) phenol ethylene oxide-modified acrylate or nonyl phenol ethylene oxide-modified acrylate in a total amount of 100 parts by mass of a (meth)acrylic compound as described in JP2008-174667A.

The thickness of the polarizer is not particularly limited. The thickness is preferably 1 to 60 μm, more preferably 1 to 30 μm, and even more preferably 2 to 20 μm.

<Polymer Film>

The polymer film is not particularly limited, and a polymer film which is generally used (for example, polarizer protective film) can be used.

Specific examples of the polymer constituting the polymer film include cellulose-based polymers; acrylic polymers having an acrylic ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

Among these, cellulose-based polymers (hereinafter, also referred to as “cellulose acylate”) represented by triacetyl cellulose can be preferably used.

From the viewpoint of workability and optical performance, acrylic polymers are also preferably used.

Examples of the acrylic polymers include polymethyl methacrylate and lactone ring-containing polymers described in paragraphs <0017> to <0107> of JP2009-098605A.

The thickness of the polymer film which is used as a polarizer protective film or the like is not particularly limited, and preferably 40 μm or less since the thickness of the optical laminate can be reduced. The lower limit is not particularly limited, and generally 5 μm or greater.

In the invention, the thickness of the support is not particularly limited. The thickness is preferably 1 to 100 μm, more preferably 5 to 50 μm, and even more preferably 5 to 20 μm. In a case where the polarizer and the polymer film are all included, the thickness of the support refers to a total of thicknesses of the polarizer and the polymer film.

In an aspect in which a polymer film is used as the support which is peelable from the optical laminate, a cellulose-based polymer or a polyester-based polymer can be preferably used. The thickness of the polymer film is not particularly limited. The thickness is preferably 5 μm to 100 μm, and more preferably 20 μm to 90 μm due to handling during the manufacturing. The interface where peeling is performed may be between the support and the photo-alignment film or between the photo-alignment film and the optically anisotropic layer. The peeling may be performed at another interface.

[Image Display Device]

Since the optical laminate according to the embodiment of the invention can be reduced in thickness by peeling off the support, it can be used suitably in the production of an image display device.

The display element which is used in the image display device according to the invention is not particularly limited, and examples thereof include a liquid crystal cell, an organic electroluminescence (hereinafter, electroluminescence “EL”) display panel, and a plasma display panel.

Among these, a liquid crystal cell or an organic EL display panel is preferable, and a liquid crystal cell is more preferable. That is, the image display device is preferably a liquid crystal display device using a liquid crystal cell as a display element or an organic EL display device using an organic EL display panel as a display element, and more preferably a liquid crystal display device.

[Liquid Crystal Display Device]

A liquid crystal display device as an example of the image display device is a liquid crystal display device having the above-described optical laminate according to the embodiment of the invention and a liquid crystal cell.

In the invention, the optical laminate according to the embodiment of the invention is preferably used as a front-side polarizing plate among polarizing plates provided on both sides of the liquid crystal cell.

Hereinafter, the liquid crystal cell constituting the liquid crystal display device will be described in detail.

<Liquid Crystal Cell>

The liquid crystal cell which is used in the liquid crystal display device is preferably a vertical alignment (VA) mode, an optically compensated bend (OCB) mode, an in-plane-switching (IPS) mode, or a twisted nematic (TN) mode, but is not limited thereto.

In a TN mode liquid crystal cell, rod-like liquid crystalline molecules (rod-like liquid crystal compound) are substantially horizontally aligned with no voltage application thereto, and subjected to twist alignment of 60° to 120°. The TN mode liquid crystal cell is the most frequently used as a color TFT liquid crystal display device, and there are descriptions in many literatures.

In a VA mode liquid crystal cell, rod-like liquid crystalline molecules are substantially vertically aligned with no voltage application thereto. The VA mode liquid crystal cell may be any one of (1) a VA mode liquid crystal cell in the narrow sense in which rod-like liquid crystalline molecules are substantially vertically aligned with no voltage application thereto, but are substantially horizontally aligned in the presence of voltage application thereto (described in JP1990-176625A (JP-H2-176625A)); (2) a (multi-domain vertical alignment (MVA) mode) liquid crystal cell attaining multi-domain of the VA mode for view angle enlargement (described in SID97, Digest of tech. Papers (proceedings) 28 (1997), 845), (3) an (n-axially symmetric aligned microcell (ASM) mode) liquid crystal cell in which rod-like liquid crystalline molecules are substantially vertically aligned with no voltage application thereto, but are subjected to twist multi-domain alignment in the presence of voltage application thereto (described in proceedings of Japan Liquid Crystal Debating Society, 58 to 59 (1998)), and (4) a super ranged viewing by vertical alignment (SURVIVAL) mode liquid crystal cell (published in liquid crystal display (LCD) International 98). In addition, the VA mode liquid crystal cell may be any one of a patterned vertical alignment (PVA) type, an optical alignment type, and a polymer-sustained alignment (PSA) type. The details of the modes are described in JP2006-215326A and JP2008-538819A.

In an IPS mode liquid crystal cell, rod-like liquid crystalline molecules are aligned to be substantially parallel to the substrate. The liquid crystalline molecules planarly respond by the application of an electric field parallel to a substrate surface. In the IPS mode, black display is performed during application of no electric field, and the absorption axes of a pair of upper and lower polarizing plates are perpendicular to each other. A method of improving a view angle by reducing light leakage at the time of black display in an oblique direction by using an optical compensation sheet is disclosed in JP1998-054982A (JP-H10-054982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

### EXAMPLES

Hereinafter, the invention will be more specifically described based on examples. Materials, used amounts, ratios, treatment contents, treatment procedures, and the like of the following examples are able to be suitably changed unless the changes cause deviance from the gist of the invention. Therefore, the range of the invention will not be restrictively interpreted by the following examples.

[Synthesis of Monomer mA-1]

As a monomer forming the above-described repeating unit A-1, the following monomer mA-1 was synthesized using 2-hydroxyethyl methacrylate (HEMA) (TOKYO CHEMICAL INDUSTRY CO., LTD.) and cinnamic acid chloride (TOKYO CHEMICAL INDUSTRY CO., LTD.) according to a method described in Langmuir, 32 (36), 9245-9253 (2016).

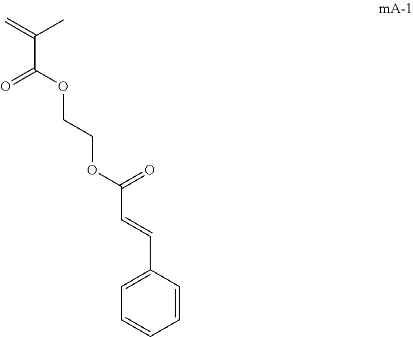

[Synthesis of Monomer mA-2, etc.]

The following monomers mA-2, mA-4, mA-5, mA-6, mA-8, mA-18, mA-22, mA-24, mA-37, mA-96, mA-98, mA-100, mA-114, and mA-115 were synthesized in the same manner as in the case of the monomer mA-1, except that the cinnamic acid chloride was changed to a corresponding cinnamic acid chloride derivative in the synthesis of the monomer mA-1.

The following monomer mA-2 and the like respectively correspond to monomers forming the above-described repeating unit A-2 and the like.

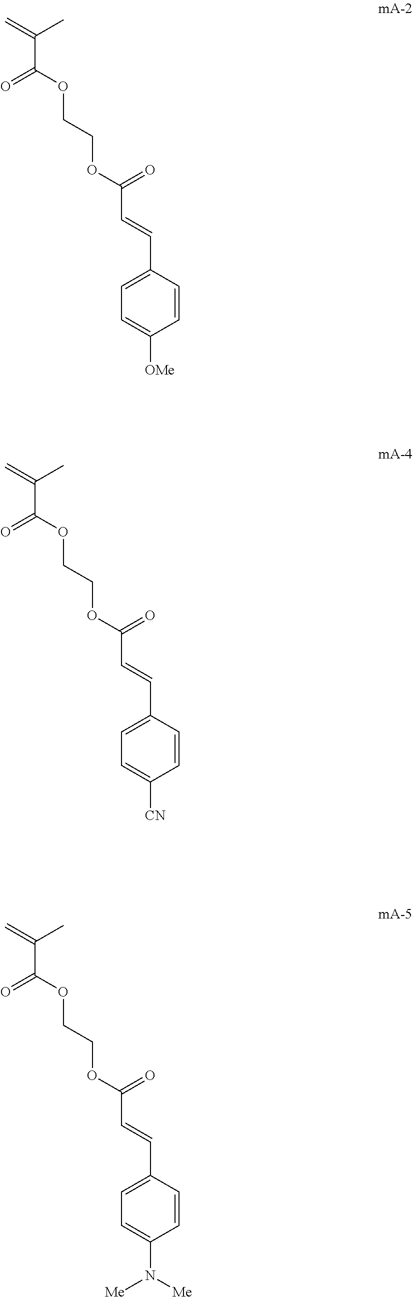

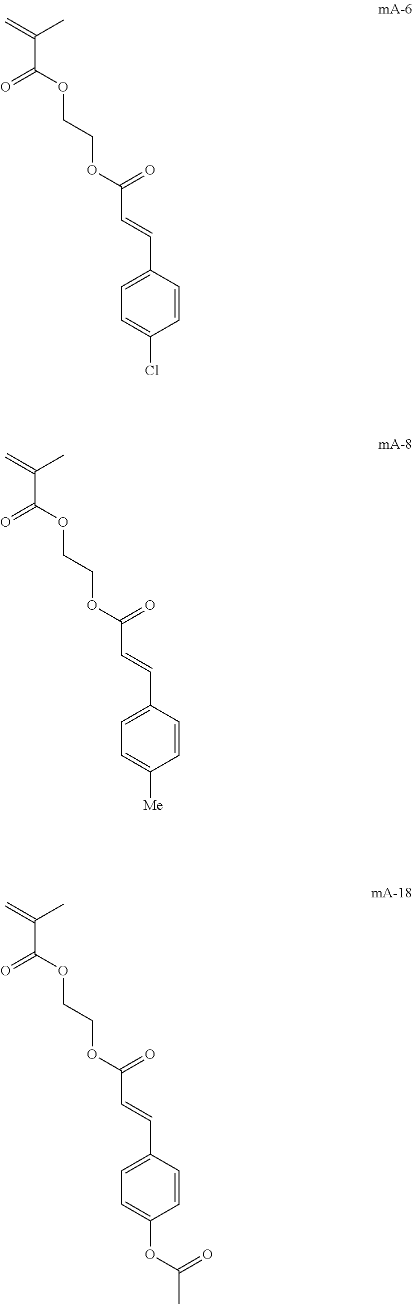

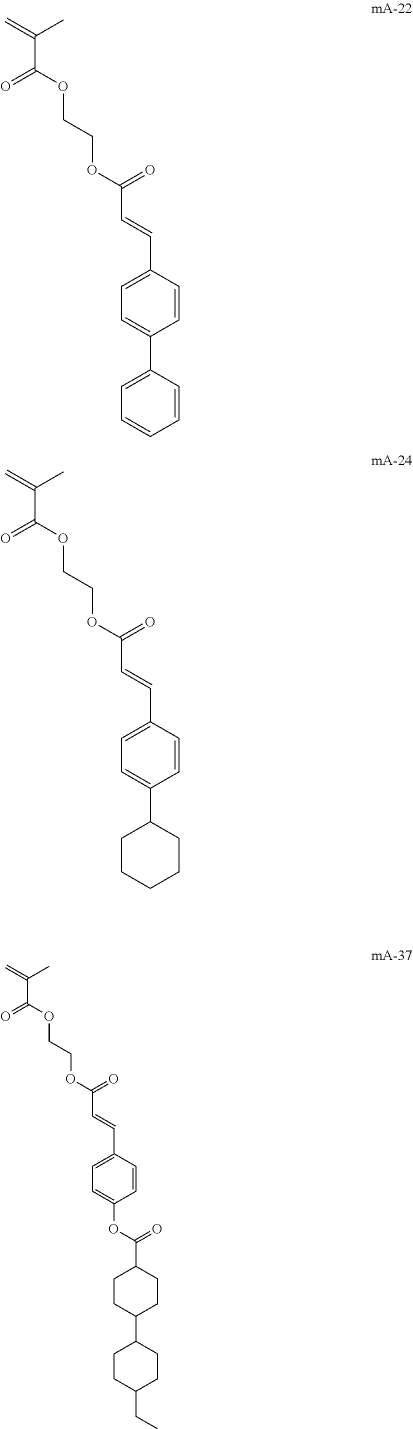

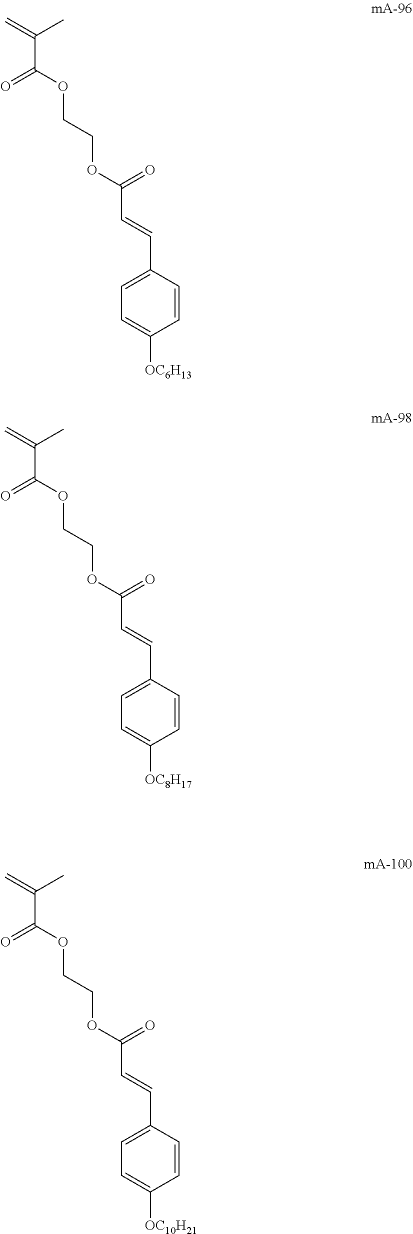

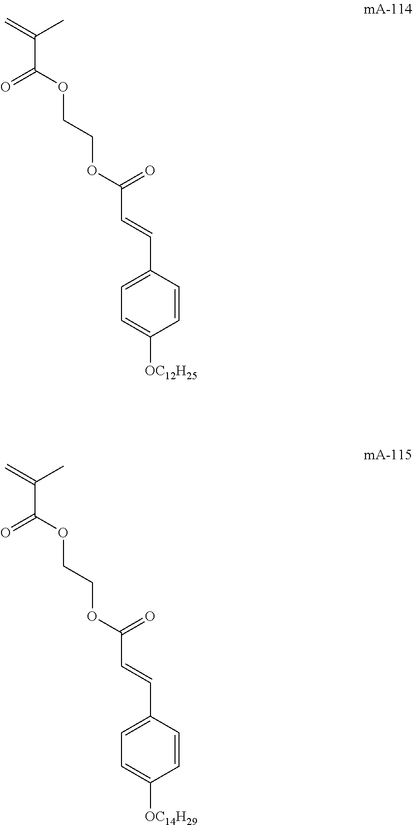

[Synthesis of Monomer mA-107]

<Synthesis of mA-107 Intermediate>

14.0 g of 4-hydroxymethyl cyclohexanol, 24.7 g of 1-(3-dimethylaminopropyl)-3-ethylcarbodiimide hydrochloride, 5.4 g of triethylamine, 6.57 g of N,N-dimethyl-4-aminopyridine, and 140 mL of methylene chloride were put into a 300 mL three-necked flask comprising a stirring blade, a thermometer, a dropping funnel, and a reflux pipe, and stirred at room temperature (23° C.).

Next, 11.1 g of a methacrylic acid was added dropwise using the dropping funnel at room temperature for 30 minutes, and after completion of the dropwise addition, the mixture was stirred at 50° C. for 5 hours.

The reaction liquid was cooled to room temperature, and then subjected to liquid separation and washed with water. The obtained organic layer was dried by anhydrous magnesium sulfate and concentrated, and thus a pale yellow liquid was obtained.

The obtained pale yellow liquid was purified with a silica gel column (developing solvent, hexane/ethyl acetate=2/1), and thus 15.3 g of 4-methacryloxymethyl cyclohexanol as a target mA-107 intermediate (yield 71%) was obtained as an amorphous solid.

<Synthesis of Monomer mA-107>

The following monomer mA-107 was synthesized in the same manner as in the case of the monomer mA-1, except that 2-hydroxyethyl methacrylate (HEMA) was changed to the mA-107 intermediate (4-methacryloxymethyl cyclohexanol) and the cinnamic acid chloride was changed to a corresponding cinnamic acid chloride derivative in the synthesis of the monomer mA-1. The following monomer mA-107 corresponds to a monomer forming the above-described repeating unit A-107.

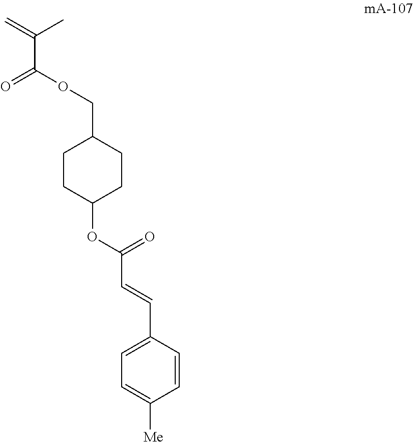

[Synthesis of Monomer mA-49]

<Synthesis of mA-49 Intermediate>

An mA-49 intermediate was synthesized in the same manner as in the case of the mA-107 intermediate, except that 4-hydroxymethyl cyclohexanol was changed to 1,4-cyclohexanediol in the synthesis of the monomer mA-107.

<Synthesis of Monomer mA-49>

The synthesis was performed in the same manner as in the case of the monomer mA-107, except that 2-hydroxyethyl methacrylate (HEMA) was changed to the mA-49 intermediate and the cinnamic acid chloride was changed to a corresponding cinnamic acid chloride derivative in the synthesis of the monomer mA-1, and the purification was performed with a silica gel column (developing solvent, hexane/ethyl acetate=4/1) to synthesize the following monomer mA-49 in which the linking site (1,4-cyclohexyl group) was 100% trans isomer. The following monomer mA-49 corresponds to a monomer forming the trans isomer of the above-described repeating unit A-49.

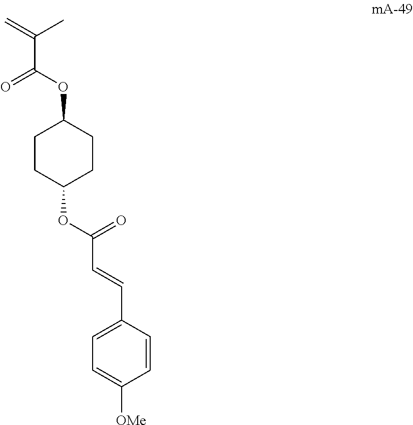

[Synthesis of Monomer mA-116]

<Synthesis of mA-116 Intermediate>

An mA-116 intermediate was synthesized in the same manner as in the case of the mA-107 intermediate, except that 4-hydroxymethyl cyclohexanol as a raw material was changed to 1,4-cyclohexanediol.

<Synthesis of Monomer mA-116>

The synthesis was performed in the same manner as in the case of the monomer mA-107, except that 2-hydroxyethyl methacrylate (HEMA) as a raw material was changed to the mA-116 intermediate and the cinnamic acid chloride was changed to a corresponding cinnamic acid chloride derivative, and the purification was performed with a silica gel column (developing solvent, hexane/ethyl acetate=4/1) to synthesize the following monomer mA-116 in which the linking site (1,4-cyclohexyl group) was 100% trans isomer. The following monomer mA-116 corresponds to a monomer forming the trans isomer of the above-described repeating unit A-116.

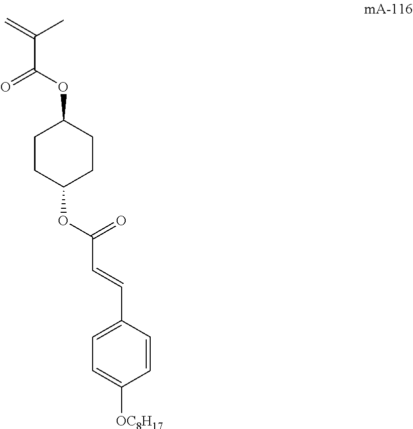

[Synthesis of Monomer mB-1]

The following monomer mB-1 forming the repeating unit B-1 was synthesized by a known urethanization reaction using an alcohol and an isocyanate from 3,4-epoxycyclohexylmethanol and 2-methacryloyloxyethyl isocyanate [KARENZ MOI (registered trademark), manufactured by SHOWA DENKO K.K.].

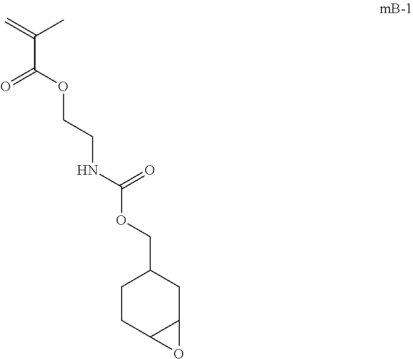

[Monomer mB-3]

CYCLOMER M100 (manufactured by Daicel Corporation) was used as the following monomer mB-3 forming the above-described repeating unit B-3.

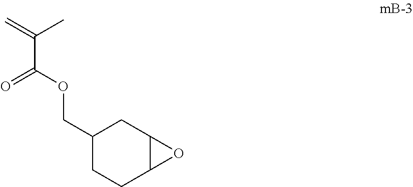

[Synthesis of Monomer mB-4]

The following monomer mB-4 forming the repeating unit B-4 was synthesized by a known esterification reaction using an alcohol and an acid chloride from 3,4-epoxycyclohexylmethanol synthesized by a method described in Tetrahedron Letters, 43, 1001-1003 (2002) and acrylic acid chloride (TOKYO CHEMICAL INDUSTRY CO., LTD.).

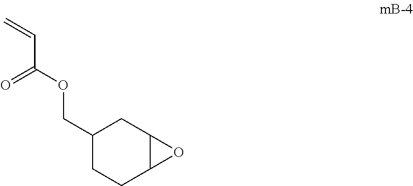

[Monomer mC-1, etc.]

Commercially available methacrylic acid (FUJIFILM Wako Pure Chemical Corporation) was used as the following monomer mC-1, commercially available 2-hydroxyethyl methacrylate (TOKYO CHEMICAL INDUSTRY CO., LTD.) was used as the following monomer mC-3, commercially available 2-methacryloyloxyethyl succinate (SHIN-NAKAMURA CHEMICAL CO, LTD.) was used as the following monomer mC-4, commercially available -butyl methacrylate (FUJIFILM Wako Pure Chemical Corporation) was used as the following monomer mC-5, commercially available 2-methacryloyloxyethyl phthalic acid (SHIN-NAKAMURA CHEMICAL CO, LTD.) was used as the following monomer mC-7, and commercially available 2-hydroxyethyl methacrylamide (TOKYO CHEMICAL INDUSTRY CO., LTD.) was used as the following monomer mC-12.

The following monomer mC-1 and the like respectively correspond to monomers forming the above-described repeating unit C-1 and the like.

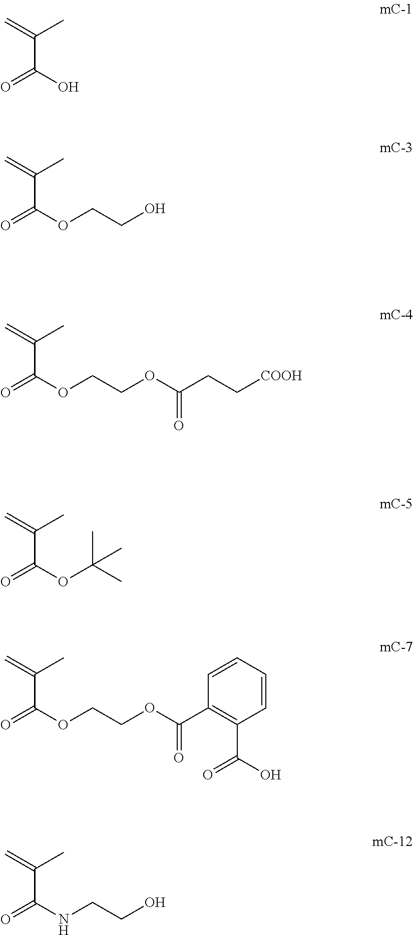

[Other Monomers]

Commercially available 2-(3,4-epoxycyclohexyl)ethyltrimethoxysilane (TOKYO CHEMICAL INDUSTRY CO., LTD.) was used as the following monomer mD-2, commercially available ethylene glycol monoacetoacetate monomethacrylate (TOKYO CHEMICAL INDUSTRY CO., LTD.) was used as the following monomer mD-4, and commercially available glycidyl methacrylate (TOKYO CHEMICAL INDUSTRY CO., LTD.) was used as the following monomer mD-5.

As the following monomer mD-1, a monomer synthesized according to Synthesis Example 3 described in JP2014-012823A.

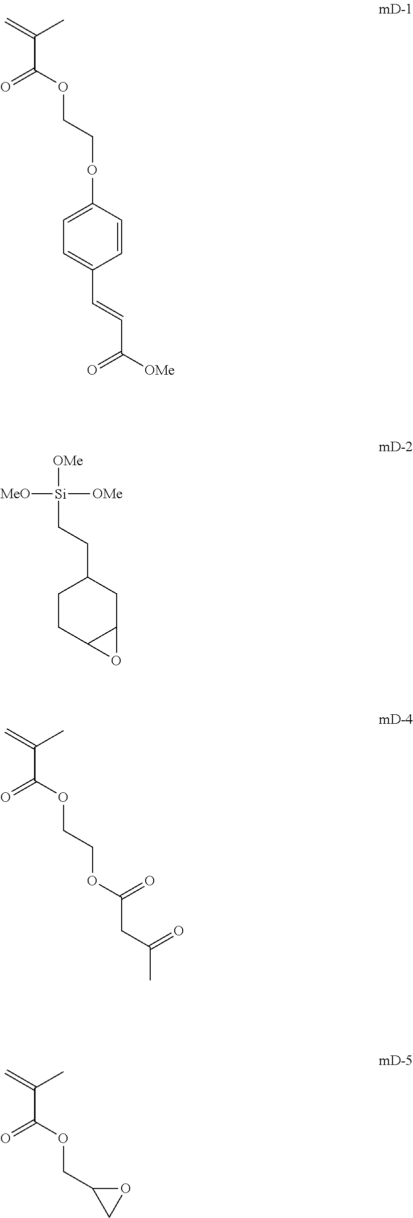

Here, the above-described monomer mD-1 and the like respectively correspond to monomers forming the following repeating unit D-1 and the like. The following repeating unit D-3 is a repeating unit synthesized by synthesizing a polyorganosiloxane using the above-described monomer mD-2 according to a method described in paragraphs <0248> and <0258> of JP5790156B, and by then causing a reaction with a 4-methoxycinnamic acid.

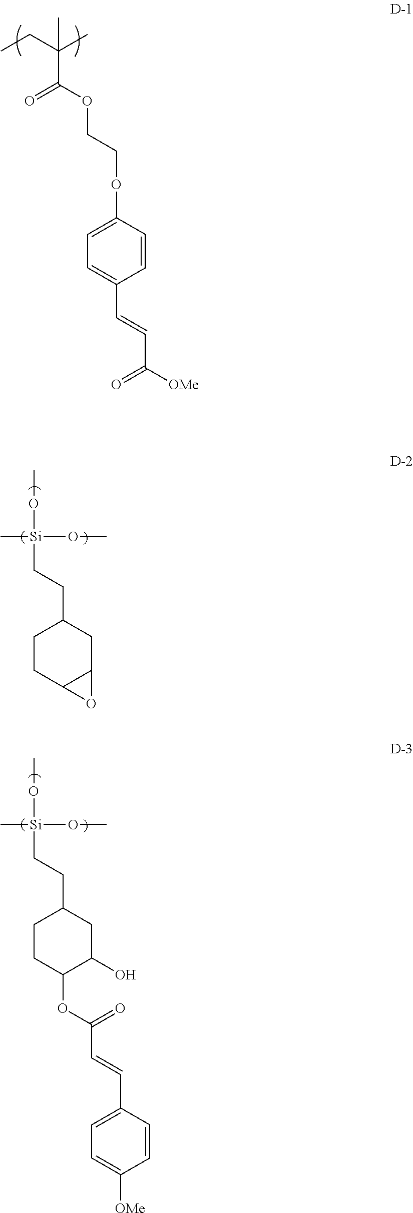

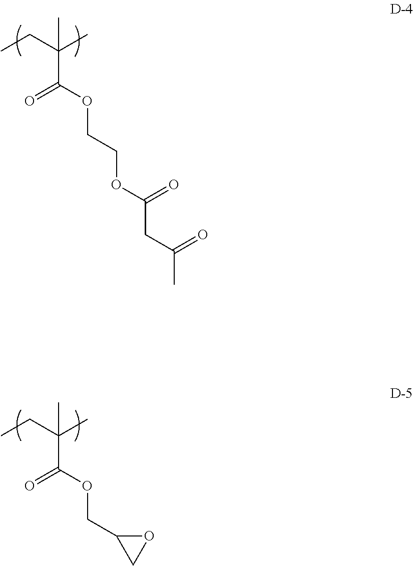

### Example 1

5 parts by mass of 2-butanone as a solvent was put into a flask comprising a cooling pipe, a thermometer, and a stirrer, and the refluxing was performed by heating in a water bath with nitrogen flowing into the flask at 5 mL/min. Here, a solution obtained by mixing 3 parts by mass of the monomer mA-5, 7 parts by mass of the monomer mB-1, 1 part by mass of 2,2′-azobis(isobutyronitrile) as a polymerization initiator, and 5 parts by mass of 2-butanone as a solvent was added dropwise thereto for 3 hours, and the mixture was stirred while maintaining the refluxing state for 3 hours. After completion of the reaction, the reaction liquid was allowed to cool to room temperature, and 30 parts by mass of 2-butanone was added and diluted to obtain about 20 mass % of a polymer solution. The obtained polymer solution was poured into a large excess of methanol to precipitate the polymer, and the collected precipitate was separated by filtering and washed with a large amount of methanol. Then, the resulting material was subjected to blast drying at 50° C. for 12 hours, and thus a polymer P-1 having a photo-alignment group was obtained.

### Examples 2 to 31 and Comparative Examples 1 to 5

Polymers were synthesized in the same manner as in the case of the polymer P-1 synthesized in Example 1, except that the synthesized monomers were respectively used as monomers forming the repeating units shown in the following Table 1, the amount of the polymerization initiator to be added was changed such that the weight-average molecular weights were as shown in the following Table 1, and the amount of the monomer to be blended was changed such that the contents of the repeating units were as shown in the following Table 1.

The weight-average molecular weight of each of the synthesized polymers was measured by the method described above. The results are shown in the following Table 1.

TABLE 1

| | | | | Con- | Weight- |
|---|---|---|---|---|---|
| | | Repeating Units | | tent* | Average |
| | | Repeating | Repeating | X/(X + | Molecular |
| | Polymer | Unit A, etc. | Unit B, etc. | Y) | Weight |
| Example 1 | P-1 | A-5 | B-1 | 0.3 | 12000 |
| Example 2 | P-2 | A-6 | B-4 | 0.3 | 12000 |
| Example 3 | P-3 | A-24 | B-3 | 0.8 | 12000 |
| Example 4 | P-4 | A-4 | B-3 | 0.3 | 12000 |
| Example 5 | P-5 | A-1 | B-3 | 0.25 | 12000 |
| Example 6 | P-6 | A-2 | B-3 | 0.8 | 12000 |
| Example 7 | P-7 | A-2 | B-3 | 0.5 | 12000 |
| Example 8 | P-8 | A-2 | B-3 | 0.6 | 12000 |
| Example 9 | P-9 | A-2 | B-3 | 0.7 | 12000 |
| Example 10 | P-10 | A-2 | B-3 | 0.6 | 40000 |
| Example 11 | p-11 | A-5 | B-3 | 0.6 | 37000 |
| Example 12 | P-12 | A-6 | B-3 | 0.6 | 42000 |
| Example 13 | P-13 | A-8 | B-3 | 0.6 | 47000 |
| Example 14 | P-14 | A-18 | B-3 | 0.6 | 37000 |
| Example 15 | P-15 | A-22 | B-3 | 0.6 | 40000 |
| Example 16 | P-16 | A-24 | B-3 | 0.6 | 40000 |
| Example 17 | P-17 | A-37 | B-3 | 0.6 | 38000 |
| Example 18 | P-18 | A-2 | B-3 | 0.4 | 40000 |
| Example 19 | P-19 | A-8 | B-3 | 0.35 | 44000 |
| Example 20 | P-20 | A-96 | B-3 | 0.5 | 38000 |
| Example 21 | P-21 | A-107 | B-3 | 0.5 | 36000 |
| Example 22 | P-22 | A-2 | B-3 | 0.5 | 22000 |
| Example 23 | P-23 | A-2 | B-3 | 0.5 | 28000 |
| Example 24 | P-24 | A-2 | B-3 | 0.5 | 57000 |
| Example 25 | P-25 | A-2 | B-3 | 0.5 | 150000 |
| Example 26 | P-26 | A-49 | B-3 | 0.5 | 40000 |
| Example 27 | P-27 | A-98 | B-3 | 0.5 | 90000 |
| Example 28 | P-28 | A-100 | B-3 | 0.5 | 150000 |
| Example 29 | P-29 | A-114 | B-3 | 0.4 | 100000 |
| Example 30 | P-30 | A-115 | B-3 | 0.4 | 120000 |
| Example 31 | P-31 | A-116 | B-3 | 0.3 | 70000 |
| Comparative | H-1 | A-2 | — | 1.0 | 35000 |
| Example 1 | | | | | |
| Comparative | H-2 | D-1 | C-3 | 0.6 | 35000 |
| Example 2 | | | | | |
| Comparative | H-3 | D-3 | D-2 | 0.6 | 15000 |
| Example 3 | | | | | |
| Comparative | H-4 | A-22 | D-4 | 0.3 | 12000 |
| Example 4 | | | | | |
| Comparative | H-5 | A-18 | D-5 | 0.3 | 12000 |
| Example 5 | | | | | |

*The content of the repeating unit in the column of “Repeating Unit A, etc.” is represented by X, and the content of the repeating unit in the column of “Repeating Unit B, etc.” is represented by Y.

[Preparation of Photo-Alignment Film Composition]

1 part by mass of the polymer P-3 synthesized in Example 3 and 0.05 parts by mass of a thermal acid generator represented by the following structural formula were added with respect to 100 parts by mass of tetrahydrofuran, and a photo-alignment film composition was prepared.

In the same manner, photo-alignment film compositions were respectively prepared in which 1 part by mass of each of the polymers synthesized in Examples 5, 7, 9, 10, 18 to 21, and 25 to 31 and Comparative Examples 1 to 5 was added with respect to 100 parts by mass of tetrahydrofuran.

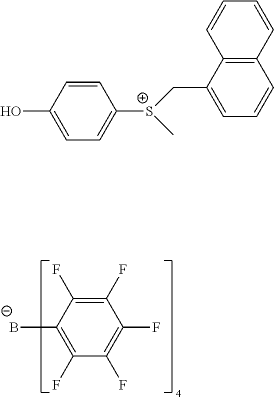

[Production of Optical Laminate]

Optical laminates of Examples 3, 5, 7, 9, 10, 18 to 21, and 25 to 31 and Comparative Examples 1 to 5 were produced with the following procedure.

As a cellulose acylate film, the same one as Comparative Example 1 of JP2014-164169A was used.

Each photo-alignment film composition prepared previously was coated on one surface of the film by a bar coater. After the coating, the solvent was removed by drying for 5 minutes on a hot plate at 80° C. to form a photo-isomerization composition layer having a thickness of 0.2 μm. The obtained photo-isomerization composition layer was irradiated with polarized ultraviolet light (10 mJ/cm², using an extra-high-pressure mercury lamp) to form a photo-alignment film.

Next, a nematic liquid crystal compound (ZLI-4792, manufactured by Merck KGaA) was coated on the photo-alignment film by a bar coater to form a composition layer. The formed composition layer was heated to 90° C. on a hot plate, and then cooled to 60° C. to stabilize the alignment.

Then, the temperature was kept at 60° C., and the alignment was fixed by ultraviolet irradiation (500 mJ/cm², using an extra-high-pressure mercury lamp) under a nitrogen atmosphere (with an oxygen concentration of 100 ppm). An optically anisotropic layer having a thickness of 2.0 μm was formed, and an optical laminate was produced.

### Example 32

An optical laminate of Example 32 was produced in the same manner as in Example 18, except that the following optically anisotropic layer coating liquid (liquid crystal 101) was used in place of the nematic liquid crystal compound coated on the photo-alignment film in the production of the optical laminate of Example 18.

Optically Anisotropic Layer Coating Liquid (liquid crystal 101)

| | | |
|---|---|---|
| Following Liquid Crystal Compound L-1 | 80.00 | parts by mass |
| Following Liquid Crystal Compound L-2 | 20.00 | parts by mass |
| Polymerization Initiator (IRGACURE 184, manufactured by BASF SE) | 3.00 | parts by mass |
| Polymerization Initiator (IRGACURE OXE-01, manufactured by BASF SE) | 3.00 | parts by mass |
| Leveling Agent (following compound G-1) | 0.20 | parts by mass |
| Methyl Ethyl Ketone | 424.8 | parts by mass |

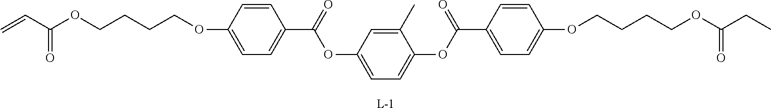

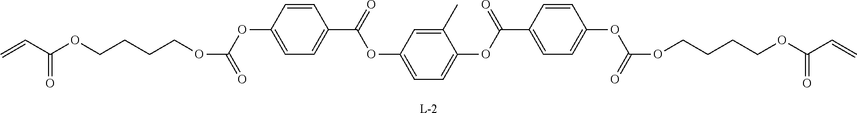

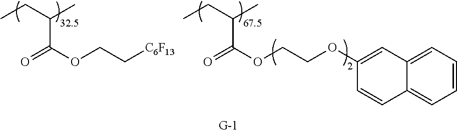

### Example 33

An optical laminate of Example 33 was produced in the same manner as in Example 18, except that the following optically anisotropic layer coating liquid (liquid crystal 102) was used in place of the nematic liquid crystal compound coated on the photo-alignment film in the production of the optical laminate of Example 18.

Optically Anisotropic Layer Coating Liquid (liquid crystal 102)

| | | |
|---|---|---|
| Following Liquid Crystal Compound L-3 | 42.00 | parts by mass |
| Following Liquid Crystal Compound L-4 | 42.00 | parts by mass |
| Following Polymerizable Compound A-1 | 16.00 | parts by mass |
| Following Polymerization Initiator S-1 | 0.50 | parts by mass |
| (oxime type) | | |
| Leveling Agent (following compound G-1) | 0.20 | parts by mass |
| HISOLVE MTEM (manufactured by TOHO | 2.00 | parts by mass |
| Chemical Industry Co., Ltd.) | | |
| NK Ester A-200 (manufactured by SHIN- | 1.00 | part by mass |
| NAKAMURA CHEMICAL CO, LTD.) | | |
| Methyl Ethyl Ketone | 424.8 | parts by mass |

The group adjacent to the acryloyloxy group of the following liquid crystal compounds L-3 and L-4 represents a propylene group (group in which a methyl group was substituted with an ethylene group). Each of the following liquid crystal compounds L-3 and L-4 represents a mixture of regioisomers with different methyl group positions.

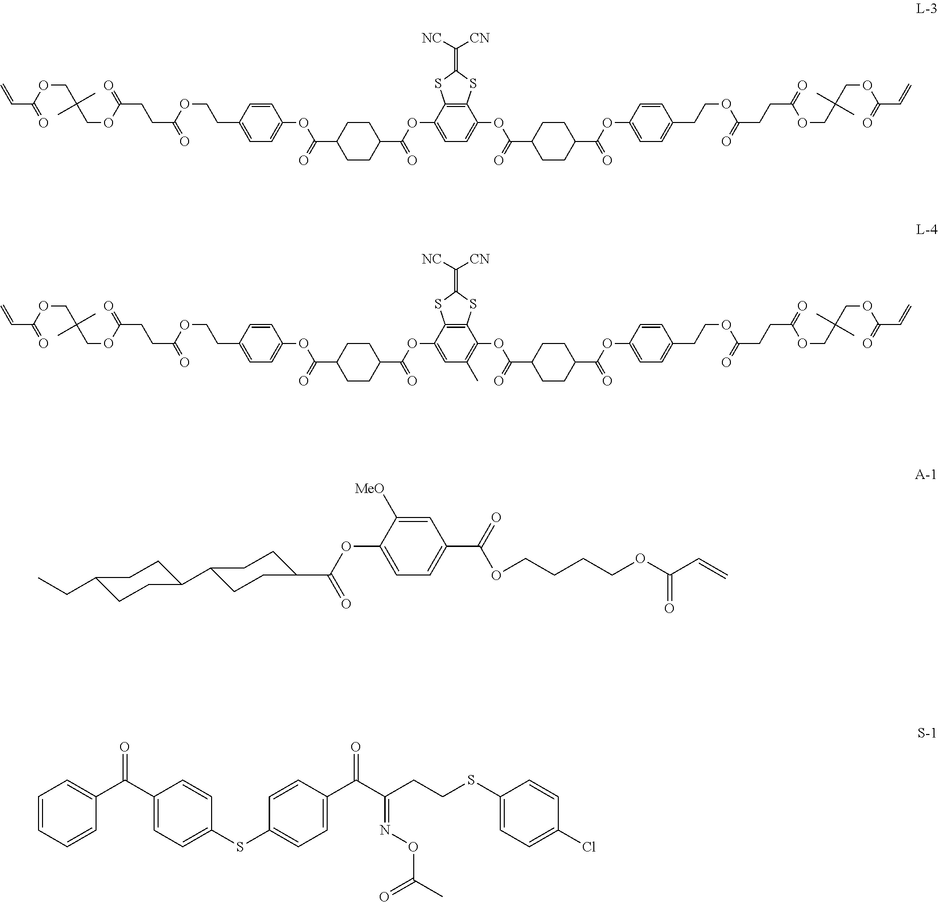

[Liquid Crystal Aligning Properties]

The produced optical laminates were observed using a polarizing microscope in a state of being deviated by 2 degrees from the extinction position. The results thereof were evaluated with the following criteria. The results are shown in the following Table 2.

AAAA: The liquid crystal director is uniformly adjusted and aligned, and the plane state and display performance are extremely excellent.

AAA: The liquid crystal director is uniformly adjusted and aligned, and the plane state and display performance are more excellent.

AA: The liquid crystal director is uniformly adjusted and aligned, and display performance is excellent.

A: There is no disorder of liquid crystal director, and the plane state is stable.

B: There is slight disorder of liquid crystal director, and the plane state is stable.

C: There is partial disorder of liquid crystal director, and the plane state is stable.

D: The liquid crystal director is significantly disordered, the plane state is unstable, and thus display performance is very poor.

In this specification, the stable plane state means a state in which defects such as unevenness or alignment failures do not occur in a case where the optical laminate is installed and observed between two polarizing plates in crossed Nicol arrangement.

In this specification, the liquid crystal director means a vector in a direction (alignment main axis) in which the major axis of liquid crystalline molecules is aligned.

[Heat Resistance]

The produced photo-alignment film was left for 1.5 hours at 40° C. and a relative humidity of 60% before coating with a nematic liquid crystal compound or an optically anisotropic layer coating liquid. Then, an optical laminate was produced in the same manner as in the case of the optical laminate described above to observe the above-described liquid crystal aligning properties, and evaluation was performed with the following criteria. The results are shown in the following Table 2.

A: There is no disorder of liquid crystal director, and the plane state is stable.

B: There is slight disorder of liquid crystal director, and the plane state is stable.

C: There is partial disorder of liquid crystal director, and the plane state is poor.

D: The liquid crystal director is significantly disordered, the plane state is unstable, and thus display performance is very poor.

TABLE 2

| | | | | | Weight- | Liquid | |
|---|---|---|---|---|---|---|---|
| | | Repeating Units | | Content* | Average | Crystal | |
| | | Repeating | Repeating | X/ | Molecular | Aligning | Heat |
| | Polymer | Unit A, etc. | Unit B, etc. | (X + Y) | Weight | Properties | Resistance |
| Example 3 | P-3 | A-24 | B-3 | 0.8 | 12000 | B | B |
| Example 5 | P-5 | A-1 | B-3 | 0.25 | 12000 | A | B |
| Example 7 | P-7 | A-2 | B-3 | 0.5 | 12000 | A | B |
| Example 9 | P-9 | A-2 | B-3 | 0.7 | 12000 | A | A |
| Example 10 | P-10 | A-2 | B-3 | 0.6 | 40000 | AA | A |
| Example 18 | P-18 | A-2 | B-3 | 0.4 | 40000 | AAA | A |
| Example 19 | P-19 | A-8 | B-3 | 0.35 | 44000 | AAA | A |
| Example 20 | P-20 | A-96 | B-3 | 0.5 | 38000 | AAAA | A |
| Example 21 | P-21 | A-107 | B-3 | 0.5 | 36000 | AAA | A |
| Example 25 | P-25 | A-2 | B-3 | 0.5 | 150000 | AAA | A |
| Example 26 | P-26 | A-49 | B-3 | 0.5 | 40000 | AAA | A |
| Example 27 | P-27 | A-98 | B-3 | 0.5 | 90000 | AAAA | A |
| Example 28 | P-28 | A-100 | B-3 | 0.5 | 150000 | AAAA | A |
| Example 29 | P-29 | A-114 | B-3 | 0.4 | 100000 | AAAA | A |
| Example 30 | P-30 | A-115 | B-3 | 0.4 | 120000 | AAAA | A |
| Example 31 | P-31 | A-116 | B-3 | 0.3 | 70000 | AAAA | A |
| Example 32 | P-18 | A-2 | B-3 | 0.4 | 40000 | AAA | A |
| Example 33 | P-18 | A-2 | B-3 | 0.4 | 40000 | AAA | A |
| Comparative | H-1 | A-2 | — | 1.0 | 35000 | D | C |
| Example 1 | | | | | | | |
| Comparative | H-2 | D-1 | C-3 | 0.6 | 35000 | D | C |
| Example 2 | | | | | | | |
| Comparative | H-3 | D-3 | D-2 | 0.6 | 15000 | A | D |
| Example 3 | | | | | | | |
| Comparative | H-4 | A-22 | D-4 | 0.3 | 12000 | C | C |
| Example 4 | | | | | | | |
| Comparative | H-5 | A-18 | D-5 | 0.3 | 12000 | B | C |
| Example 5 | | | | | | | |

*The content of the repeating unit in the column of “Repeating Unit A, etc.” is represented by X, and the content of the repeating unit in the column of “Repeating Unit B, etc.” is represented by Y.

From the results shown in Table 2, a photo-alignment film formed of a polymer which does not have a repeating unit including a crosslinkable group has been found to be poor in both the aligning properties and the heat resistance (Comparative Example 1).

Moreover, a photo-alignment film formed of a copolymer having a repeating unit including a photo-alignment group not corresponding to Formula (1) and a repeating unit including a crosslinkable group not corresponding to Formula (2) has been found to be poor in both the aligning properties and the heat resistance (Comparative Example 2).

In addition, a photo-alignment film formed of a copolymer having a siloxane skeleton as a main chain skeleton has been found to be extremely poor in the heat resistance even though it has a photo-alignment group and a crosslinkable group (Comparative Example 3). In addition, a photo-alignment film formed of a copolymer having a repeating unit A including a photo-alignment group represented by Formula (1) and a repeating unit including a crosslinkable group not corresponding to Formula (2) has been found to be poor in the heat resistance (Comparative Examples 4 and 5).

A photo-alignment film formed of a copolymer having a repeating unit A including a photo-alignment group represented by Formula (1) and a repeating unit B including a crosslinkable group represented by Formula (2) has been found to be good in both the aligning properties and the heat resistance (Examples 3, 5, 7, 9, 10, 18 to 21, and 25 to 33).

### Example 34

A polymer P-32 was synthesized in the same manner as in the case of the polymer P-1 synthesized in Example 1, except that the synthesized monomers were respectively used as monomers forming the repeating units shown in the following Table 3, and the amount of the monomer to be blended was changed such that the contents of the repeating units were as shown in the following Table 3. The weight-average molecular weight of the synthesized polymer P-32 was 36,000.

### Examples 35 to 39

Polymers P-33 to P-37 were synthesized in the same manner as in the case of the polymer P-32 synthesized in Example 34, except that the synthesized monomers were respectively used as monomers forming the repeating units shown in the following Table 3, and the amount of the monomer to be blended was changed such that the contents of the repeating units were as shown in the following Table 3.

[Production of Optical Laminate]

Optical laminates of Examples 33 to 39 and 7 were produced with the following procedure.

As a cellulose acylate film, the same one as Comparative Example 1 of JP2014-164169A was used.

Each photo-alignment film composition prepared previously was coated on one surface of the film by a bar coater. After the coating, the solvent was removed by drying for 5 minutes on a hot plate at 80° C. to form a photo-isomerization composition layer having a thickness of 0.2 μm. The obtained photo-isomerization composition layer was irradiated with polarized ultraviolet light (5 mJ/cm², using an extra-high-pressure mercury lamp) to form a photo-alignment film.

Next, a nematic liquid crystal compound (ZLI-4792, manufactured by Merck KGaA) was coated on the photo-alignment film by a bar coater to form a composition layer. The formed composition layer was heated to 90° C. on a hot plate, and then cooled to 60° C. to stabilize the alignment.

Then, the temperature was kept at 60° C., and the alignment was fixed by ultraviolet irradiation (500 mJ/cm², using an extra-high-pressure mercury lamp) under a nitrogen atmosphere (with an oxygen concentration of 100 ppm). An optically anisotropic layer having a thickness of 2.0 μm was formed, and an optical laminate was produced.

The produced optical laminate was observed using a polarizing microscope in a state of being deviated by 2 degrees from the extinction position. As a result, evaluation was performed with the following criteria. The results are shown in the following Table 3.

AAA: The liquid crystal director is uniformly adjusted and aligned, and the plane state and display performance are extremely excellent.

AA: The liquid crystal director is uniformly adjusted and aligned, and display performance is excellent.

A: There is no disorder of liquid crystal director, and the plane state is stable.

B: There is slight disorder of liquid crystal director, and the plane state is stable.

C: There is partial disorder of liquid crystal director, and the plane state is stable.

D: The liquid crystal director is significantly disordered, the plane state is unstable, and thus display performance is very poor.

TABLE 3

| | | | | | | | | Liquid |
|---|---|---|---|---|---|---|---|---|
| | | | | | | | | Crystal |
| | | | | | | | | Aligning |
| | | | | | | | | Properties |
| | | Repeating Units | | | Content | | | at Low |
| | | Repeating | Repeating | Repeating | Repeating | Repeating | Repeating | Irradiation |
| | Polymer | Unit A | Unit B | Unit C | Unit A | Unit B | Unit C | Dose |
| Example 34 | P-32 | A-98 | B-3 | C-1 | 0.4 | 0.55 | 0.05 | AAA |
| Example 35 | P-33 | A-96 | B-3 | C-4 | 0.4 | 0.58 | 0.02 | AAA |
| Example 36 | P-34 | A-2 | B-3 | C-5 | 0.3 | 0.6 | 0.1 | AA |
| Example 37 | P-35 | A-24 | B-4 | C-3 | 0.6 | 0.25 | 0.15 | A |
| Example 38 | P-36 | A-22 | B-3 | C-12 | 0.4 | 0.4 | 0.2 | A |
| Example 39 | P-37 | A-37 | B-1 | C-7 | 0.5 | 0.45 | 0.05 | AA |
| Example 7 | P-7 | A-2 | B-3 | — | 0.5 | 0.5 | — | B |

From the comparison results between Examples 34 to 39 and Example 7, a photo-alignment film formed of a copolymer having a repeating unit C represented by Formula (6) has been found to be good in the liquid crystal aligning properties even in a case where the polarized ultraviolet irradiation dose was reduced.

What is claimed is:

1. A photo-alignment copolymer comprising:
a repeating unit A including a photo-alignment group represented by Formula (1); and
a repeating unit B including a crosslinkable group represented by Formula (2), 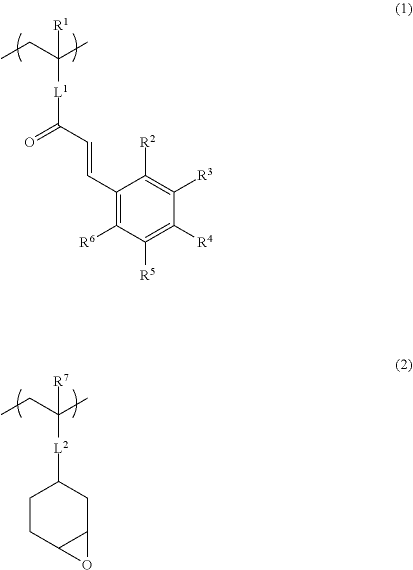
in Formula (1), R¹ represents a hydrogen atom or a methyl group, R², R³, R⁴, R⁵, and R⁶ each independently represent a hydrogen atom or a substituent, and among R², R³, R⁴, R⁵, and R⁶, two adjacent groups may be bonded to form a ring,
in Formula (2), R⁷ represents a hydrogen atom or a methyl group,
L¹ in Formula (1) and L² in Formula (2) each independently represent a divalent linking group formed by combining at least two or more groups selected from the group consisting of a linear, branched, or cyclic alkylene group having 1 to 10 carbon atoms and optionally having a substituent A, an arylene group having 6 to 12 carbon atoms and optionally having a substituent B, an ether group, a carbonyl group, and an imino group optionally having a substituent C, and
the substituent A is at least one substituent selected from the group consisting of a halogen atom, an alkyl group, and an alkoxy group, the substituent B is at least one substituent selected from the group consisting of a halogen atom, an alkyl group, an aryl group, an alkoxy group, an aryloxy group, a cyano group, a carbonyl group, and an alkoxycarbonyl group, and the substituent C is at least one substituent selected from the group consisting of an alkyl group and an aryl group.

2. The photo-alignment copolymer according to claim 1,
wherein any one of L¹ in Formula (1) and L² in Formula (2) is a divalent linking group including a branched, or cyclic alkylene group having 3 to 10 carbon atoms and optionally having a substituent A.

3. The photo-alignment copolymer according to claim 1,
wherein any one of L¹ in Formula (1) and L² in Formula (2) is a divalent linking group including an imino group optionally having a substituent C.

4. The photo-alignment copolymer according to claim 1,
wherein L¹ in Formula (1) is a divalent linking group including any of a linear alkylene group having 1 to 10 carbon atoms and optionally having a substituent A, a cyclic alkylene group having 3 to 10 carbon atoms and optionally having a substituent A, and an arylene group having 6 to 12 carbon atoms and optionally having a substituent B.

5. The photo-alignment copolymer according to claim 4,
wherein L¹ in Formula (1) is a divalent linking group including a linear alkylene group having 1 to 10 carbon atoms and optionally having a substituent A or a cyclic alkylene group having 3 to 10 carbon atoms and optionally having a substituent A.

6. The photo-alignment copolymer according to claim 5,
wherein L¹ in Formula (1) is a divalent linking group including a cyclic alkylene group having 3 to 10 carbon atoms and optionally having a substituent A.

7. The photo-alignment copolymer according to claim 1,
wherein L¹ in Formula (1) is a divalent linking group including a cyclic alkylene group having 3 to 10 carbon atoms and optionally having a substituent A or an imino group optionally having a substituent C, and L² in Formula (2) is a divalent linking group including an imino group optionally having a substituent C.

8. The photo-alignment copolymer according to claim 1,
wherein at least R⁴ among R², R³, R⁴, R⁵, and R⁶ in Formula (1) represents a substituent.

9. The photo-alignment copolymer according to claim 8,
wherein R², R³, R⁵, and R⁶ in Formula (1) all represent a hydrogen atom.

10. The photo-alignment copolymer according to claim 1,
wherein R⁴ in Formula (1) is an electron-donating substituent.

11. The photo-alignment copolymer according to claim 1,
wherein the substituents represented by R², R³, R⁴, R⁵, and R⁶ in Formula (1) each independently represent a halogen atom, a linear, branched, or cyclic alkyl group having 1 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, an amino group, or a group represented by Formula (3), 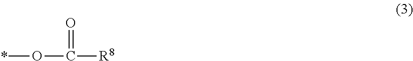
in Formula (3), * represents a bonding position with a benzene ring in Formula (1), and R⁸ represents a monovalent organic group.

12. The photo-alignment copolymer according to claim 1,
wherein a content X of the repeating unit A and a content Y of the repeating unit B satisfy Formula (4).
0.2≤X/(X+Y)≤0.8 (4)

13. The photo-alignment copolymer according to claim 12,
wherein a content X of the repeating unit A and a content Y of the repeating unit B satisfy Formula (5).
0.2≤X/(X+Y)≤0.6 (5)

14. The photo-alignment copolymer according to claim 1,
wherein a weight-average molecular weight is 10,000 to 500,000.

15. The photo-alignment copolymer according to claim 14,
wherein a weight-average molecular weight is 30,000 to 200,000.

16. The photo-alignment copolymer according to claim 1, further comprising:
a repeating unit C represented by Formula (6), 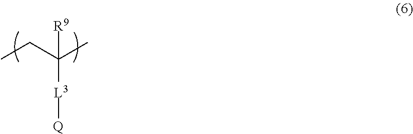
in Formula (6), R⁹ represents a hydrogen atom or a methyl group,
in Formula (6), L³ represents a divalent linking group formed by one group or combining one or more groups selected from the group consisting of a linear, branched, or cyclic alkylene group having 1 to 10 carbon atoms and optionally having the substituent A, an arylene group having 6 to 12 carbon atoms and optionally having the substituent B, an ether group, a carbonyl group, and an imino group optionally having the substituent C, and
in Formula (6), Q represents any group of —OH, —COOH, and —COOtBu.

17. A photo-alignment film which is formed using a photo-alignment film composition containing the photo-alignment copolymer according to claim 1.

18. An optical laminate comprising:
the photo-alignment film according to claim 17; and
an optically anisotropic layer which is formed using a liquid crystal composition containing a liquid crystal compound.
